(19) United States
(12) Patent Application Publication
(10) Pub. No.: US 2026/0130558 A1
(43) Pub. Date: May 14, 2026

(54) STATION AND CLEANING DEVICE

(71) Applicant: SAMSUNG ELECTRONICS CO., LTD., Suwon-si (KR)

(72) Inventors: Sinae KIM, Suwon-si (KR); Sewoong CHOI, Suwon-si (KR); Taksoo KIM, Suwon-si (KR)

(73) Assignee: SAMSUNG ELECTRONICS CO., LTD., Suwon-si (KR)

(21) Appl. No.: 19/020,026

(22) Filed: Jan. 14, 2025

Related U.S. Application Data
(63) Continuation of application No. PCT/KR2024/021457, filed on Dec. 30, 2024.

(30) Foreign Application Priority Data
Mar. 20, 2024 (KR) 10-2024-0038762
Jun. 17, 2024 (KR) 10-2024-0078560

(51) Int. Cl. A47L 11/40; A47L 11/283; B08B 9/032; F24H 9/00

(52) U.S. Cl. CPC A47L 11/4091; A47L 11/283; A47L 11/4038; B08B 9/0325; F24H 9/00; A47L 2201/028; B08B 2209/032

(57) ABSTRACT

A cleaning device may include: a robot cleaner including a main body and a wettable cloth detachably mountable on a bottom the main body; and a station to which the robot cleaner is dockable, the station including: a tank configured to store water and, during a scale removing process, to store a solution including a substance for eliminating scale, a heating device, a pump, and a controller configured to: with the robot cleaner docked, control the pump to pump water stored in the tank to the heating device to be heated, and during the scale removing process, with the robot cleaner not docked, control the pump to pump solution stored in the tank to the heating device so that scale, accumulated in the heating device by water being heated by the heating device, is removed by the substance included in the solution by the scale removing process.

### CROSS-REFERENCE TO RELATED APPLICATIONS

This is a continuation application, under 35 U.S.C. § 111(a), of International Application PCT/KR 2024/021457, filed Dec. 30, 2024, which claims priority under 35 U.S.C. § 119 to Korean Patent Application No. 10-2024-0038762, filed Mar. 20, 2024 and Korean Patent Application No. 10-2024-0078560, filed Jun. 17, 2024, in the Korean Intellectual Property Office, the disclosures of which are incorporated herein in their entireties by reference.

### TECHNICAL FIELD

The disclosure relates to a station for a robot cleaner including a wet cloth and a cleaning device including the same.

### BACKGROUND ART

In general, the robot cleaner is a device that automatically cleans a cleaning space by drawing in impurities such as dust on the floor while moving about the cleaning space without user intervention. That is, the robot cleaner cleans the cleaning space while moving around the cleaning space.

The robot cleaner detects a distance to an obstacle such as furniture, office equipment, a wall, etc., installed in a cleaning area through a distance sensor, and cleans up the cleaning area by autonomously changing directions by selectively driving left and right motors of the robot cleaner.

Recently, in addition to the robot cleaner that draws in impurities such as dust on the floor, a robot cleaner that mops the impurities such as dust on the floor has appeared. The robot cleaner may perform wet cleaning through a wet cloth.

### DISCLOSURE

### Technical Problem

The disclosure provides a station and cleaning device with better user convenience.

The disclosure provides a station and cleaning device capable of reducing occurrence of scale.

The disclosure provides a station and cleaning device capable of reducing deterioration of performance.

Technological objectives of the disclosure are not limited to what are mentioned above, and throughout the specification, it will be clearly appreciated by those of ordinary skill in the art that there may be other technological objectives unmentioned.

### Technical Solution

In accordance with the present disclosure, a cleaning device may include: a robot cleaner including a main body a wettable cloth detachably mountable on a bottom portion of the main body; and a station to which the robot cleaner is dockable, the station may include: a tank configured to store water and, during a scale removing process, to store a solution including a substance for eliminating scale, a heating device, a pump, and a controller configured to: with the robot cleaner docked to the station, control the pump to pump water stored in the tank to the heating device to be heated by the heating device, and during the scale removing process, with the robot cleaner not docked to the station, control the pump to pump solution stored in the tank to the heating device so that scale, accumulated in the heating device by water being heated by the heating device, is removed by the substance included in the solution by the scale removing process.

The station may further include a scale sensor configured to detect the scale accumulated in the heating device.

The station may further include: a washing chamber configured to, with the wettable cloth mounted on the bottom portion of the main body and with the robot cleaner docked to the station, align with the wettable cloth, a first flow path configured to guide water or solution pumped from the tank to the heating device, a second flow path branched from the first flow path and configured to guide water or solution from the first flow path to the washing chamber, and a relief valve configured to open and close the second flow path, wherein the relief valve is configured to open with an increase of internal pressure of the heating device, and the scale sensor is configured to detect opening of the relief valve, or a flow of water or solution through the second flow path.

The heating device may include: a pipe configured to allow water or solution pumped from the tank to pass therethrough; and a heater adjacent to the pipe and configured to heat water or solution passing through the pipe.

The pipe may include a first bending portion, and the heater may include a second bending portion corresponding with the first bending portion.

The heating device may include: a tub configured to store water or solution pumped from the tank; and a heater configured to heat water or solution stored in the tub.

At least a portion of the heater may be inside the tub and configured to contact and heat water or solution stored in the tub.

The heater may be outside the tub and configured to heat, without contacting, water or solution stored in the tub.

The controller may be further configured to provide a notification to a user to guide a start of the scale removing process based on the scale accumulated in the heating device being detected by the scale sensor, and the notification may include sensory information to indicate that the substance for eliminating scale is to be added into the tank.

The station may further include a washing chamber configured to, with the wettable cloth mounted on the bottom portion of the main body and with the robot cleaner docked to the station, align with the wettable cloth, and the controller may be further configured to: based on the scale removing process being started, operate the pump to pump water or solution stored in the tank to the heating device, and the water or solution pumped to the heating device by operation of the pump is discharged to the washing chamber through the pipe.

The station may further include a washing chamber configured to, with the wettable cloth mounted on the bottom portion of the main body and with the robot cleaner docked to the station, align with the wettable cloth, and the controller may be further configured to: control the pump such that steam produced by the heating device jets to the washing chamber in a steaming process, operate the pump at a first rpm in the scale removing process, and operate the pump at a second rpm greater than the first rpm in the steaming process.

The controller may be further configured to: based on the scale removing process being started, control the pump to pump solution stored in the tank to the tub in performance of a first operation, and based on a lapse of a predetermined time after the first operation is performed, control the pump to pump the solution stored in the tub to the tank in performance of a second operation.

The station may further include a washing chamber configured to, with the wettable cloth mounted on the bottom portion of the main body and with the robot cleaner docked to the station, align with the wettable cloth, and based on the scale removing process being started, the controller is further configured to: control the pump to pump solution stored in the tank to the washing chamber after the first operation and the second operation are repeated a predetermined number of times.

The station may further include: a washing chamber, a first flow path configured to guide water or solution pumped from the tank to the heating device; and a second flow path branched from the first flow path, extending upward to a predetermined height lower than a height of the tub, and then bending and extending downward toward the washing chamber, and the controller may be configured to: based on the scale removing process being started, control the pump so that a water level in the tub rises to a target water level lower than the predetermined height in performance of a first operation, and based on a lapse of a predetermined time after the first operation is performed, control the pump so that the water level rises to the predetermined height or more.

In accordance with the present disclosure, a station to which a robot cleaner is dockable, the station may include: a tank configured to store water and, during a scale removing process, to store a solution including a substance for eliminating scale; a heating device; a pump; and a controller configured to: with the robot cleaner docked to the station, control the pump to pump water stored in the tank to the heating device to be heated by the heating device, and during the scale removing process, with the robot cleaner not docked to the station, control the pump to pump solution stored in the tank to the heating device so that scale, accumulated in the heating device by water being heated by the heating device, is removed by the substance included in the solution by the scale removing process.

### DESCRIPTION OF DRAWINGS

FIG. 1 illustrates a state of a robot cleaner being separated from a station in a cleaning device, according to an embodiment of the disclosure.

FIG. 2 illustrates a state of a robot cleaner being settled in a station in a cleaning device, according to an embodiment of the disclosure.

FIG. 3 illustrates the rear of a cleaning device, according to an embodiment of the disclosure.

FIG. 4 illustrates a robot cleaner, according to an embodiment of the disclosure.

FIG. 5 illustrates the rear of a robot cleaner, according to an embodiment of the disclosure.

FIG. 6 illustrates the bottom of a robot cleaner, according to an embodiment of the disclosure.

FIG. 7 is a front view of internal components of a station, according to an embodiment of the disclosure.

FIG. 8 is a rear view of internal components of a station, according to an embodiment of the disclosure.

FIG. 9 is a rear view of an interior of a station, according to an embodiment of the disclosure.

FIG. 10 schematically illustrates internal components of a heating device by enlarging portion C shown in FIG. 9.

FIG. 11 illustrates a portion of a station, according to an embodiment of the disclosure.

FIG. 12 illustrates a state of a washing frame being separated from a washing chamber in a station, according to an embodiment of the disclosure.

FIG. 13 is a cross-sectional view of a side of a station, according to an embodiment of the disclosure.

FIG. 14 schematically illustrates some components of a station, according to an embodiment of the disclosure.

FIG. 15 is a cross-sectional view along line A-A′ marked in FIG. 3.

FIG. 16 is a cross-sectional view along line B-B′ marked in FIG. 3.

FIG. 17 is a control block diagram of a robot cleaner, according to an embodiment of the disclosure.

FIG. 18 is a control block diagram of a station, according to an embodiment of the disclosure.

FIG. 19 schematically illustrates internal components of a heating device, according to an embodiment of the disclosure.

FIG. 20 is an enlarged view of a heating device, according to an embodiment of the disclosure.

FIG. 21 is a cross-sectional view along line D-D′ marked in FIG. 20.

FIG. 22 is a flowchart illustrating an example of a procedure for a station to start a scale removing process, according to an embodiment of the disclosure.

FIG. 23 illustrates an example of a notification provided by a station, according to an embodiment of the disclosure.

FIG. 24 is a flowchart illustrating an example of a procedure for a scale removing process when a heating device includes a water pipe and a heater, according to an embodiment of the disclosure.

FIG. 25 schematically illustrates flows of water when a station performs a scale removing process, according to an embodiment of the disclosure.

FIG. 26 is a flowchart illustrating an example of a procedure for a scale removing process when a heating device includes a water tank and a heater, according to an embodiment of the disclosure.

FIG. 27 schematically illustrates flows of water when a station performs a scale removing process, according to an embodiment of the disclosure.

FIG. 28 is a flowchart illustrating another example of a procedure for a scale removing process when a heating device includes a water tank and a heater, according to an embodiment of the disclosure.

FIG. 29 schematically illustrates flows of water when a station performs a scale removing process, according to an embodiment of the disclosure.

### MODES OF THE INVENTION

It is understood that various embodiments of the disclosure and associated terms are not intended to limit technical features herein to particular embodiments, but encompass various changes, equivalents, or substitutions.

Like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “at least one of A, B, or C” may each include any one or all the possible combinations of A, B and C.

The expression “and/or” is interpreted to include a combination or any of associated elements.

A unit, module or member may be implemented in hardware or software. A plurality of units, modules or members may be implemented as one component, or a single unit, module or member may include multiple components.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

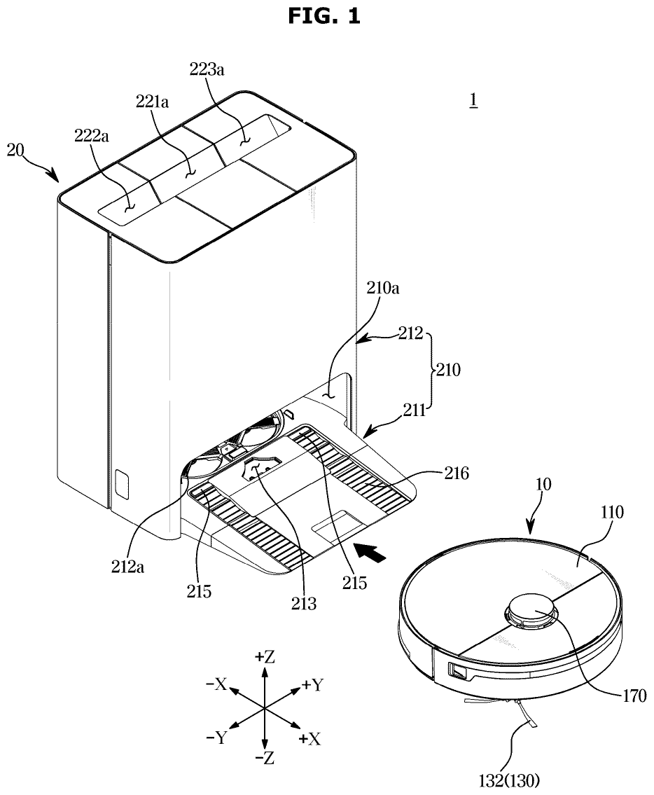

The terms “forward or front”, “rearward or behind”, “left”, and “right” as herein used are defined with respect to the drawings, but the terms may not restrict the shapes and position of the respective components. For example, as shown in FIG. 1, a direction in which a robot cleaner 10 enters a station 20 may be defined as a rearward direction (−X direction) and the opposite direction may be defined as a forward direction (+X direction).

Reference will now be made in detail to embodiments of the disclosure, which are illustrated in the accompanying drawings.

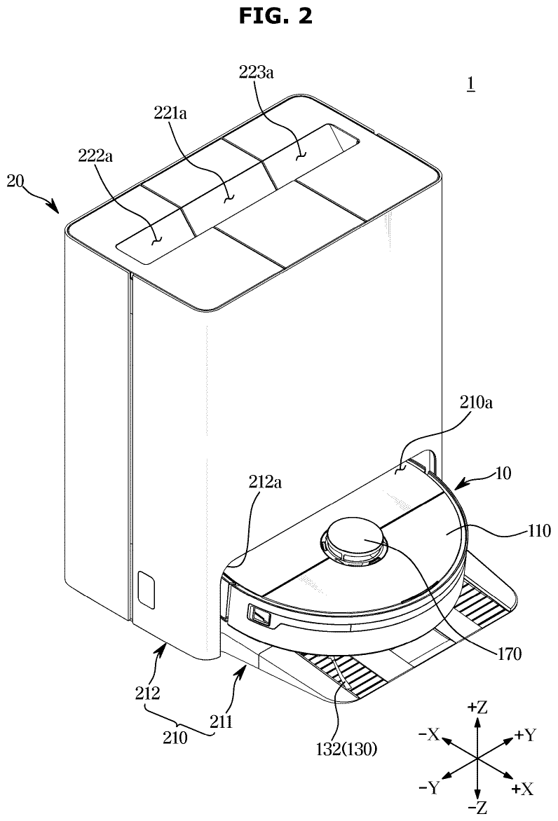

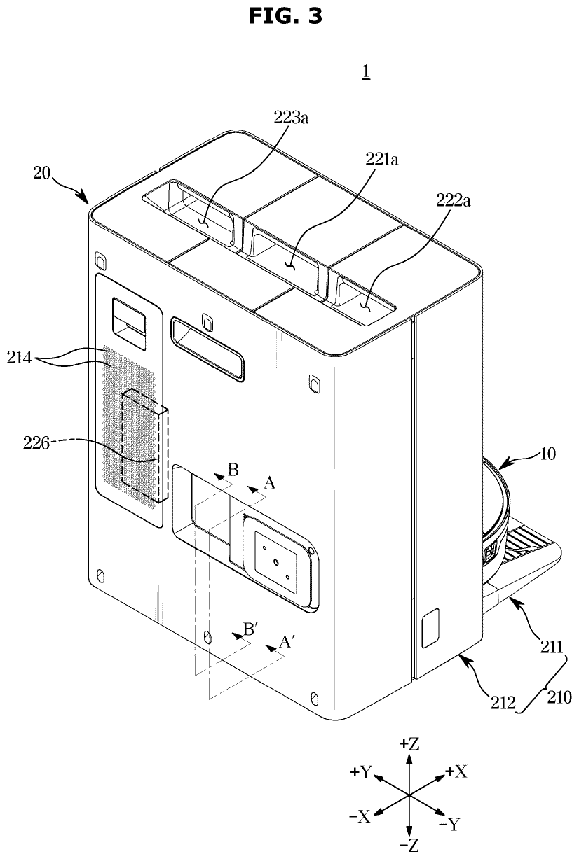

FIG. 1 illustrates a state of a robot cleaner being separated from a station in a cleaning device, according to an embodiment of the disclosure. FIG. 2 illustrates a state of a robot cleaner being settled in a station in a cleaning device, according to an embodiment of the disclosure. FIG. 3 illustrates the rear of a cleaning device, according to an embodiment of the disclosure.

Referring to FIGS. 1 to 3, a cleaning device 1 may include the robot cleaner 10 and the station 20. The cleaning device 1 may also be referred to as a cleaning system 1.

The robot cleaner 10 may clean the floor while moving across the floor. The floor to be cleaned by the robot cleaner 10 may be referred to as a surface to be cleaned. The robot cleaner 10 may perform dry cleaning and/or wet cleaning. The robot cleaner 10 may draw in or mop dirt on the surface to be cleaned. The dirt may be a collective term for impurities such as dust, hair, food crumbs, etc.

The robot cleaner 10 may be settled in the station 20. The robot cleaner 10 may be cradled in the station 20. The robot cleaner 10 may be docked (or referred to as cradled) to the station 20. At least a portion of the robot cleaner 10 may be arranged in a receiving space 210a of the station 20.

The robot cleaner 10 may move to the station during cleaning and/or after completing cleaning.

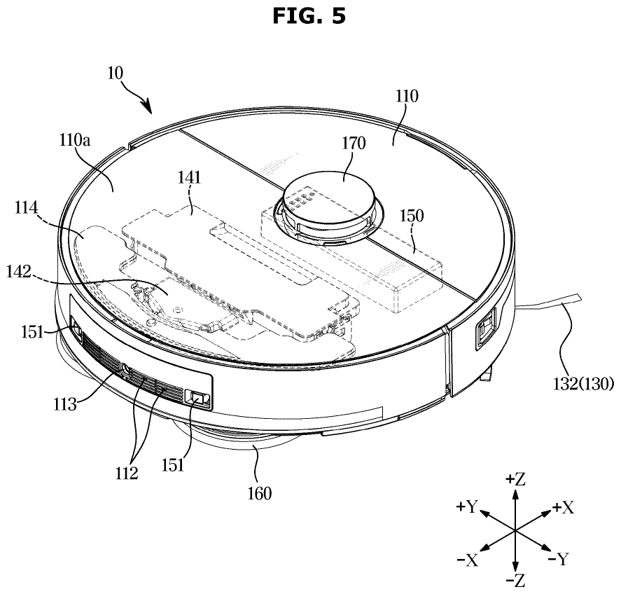

For example, the robot cleaner 10 may move to the station 20 when requiring to be charged, when requiring to empty a dust collecting tank 141 (see FIG. 5) of dirt, when a water tank 114 (see FIG. 5) runs short of water, when the water content of a wettable cloth is low, when the wettable cloth 160 needs to be cleaned, when the wettable cloth 160 needs to be sterilized and/or when the wettable cloth 160 needs to be dried.

The station 20 may be arranged to cradle the robot cleaner 10. The station 20 may be arranged such that the robot cleaner 10 is settled therein. The station 20 may be arranged to store the robot cleaner 10.

For example, while the robot cleaner 10 is settled in the station 20, the station 20 may charge a battery 150 (see FIG. 5) of the robot cleaner 10. For example, while the robot cleaner 10 is settled in the station 20, the station 20 may pick up the dirt collected in the dust collecting tank 141 of the robot cleaner 10. For example, while the robot cleaner 10 is settled in the station 20, the station 20 may supply water into the water tank 114 of the robot cleaner 10. For example, while the robot cleaner 10 is settled in the station 20, the station 20 may soak the wettable cloth 160 in water and/or steam. For example, while the robot cleaner 10 is settled in the station 20, the station 20 may wash the wettable cloth 160. For example, while the robot cleaner 10 is settled in the station 20, the station 20 may sterilize the wettable cloth 160. For example, while the robot cleaner 10 is settled in the station 20, the station 20 may dry the wettable cloth 160.

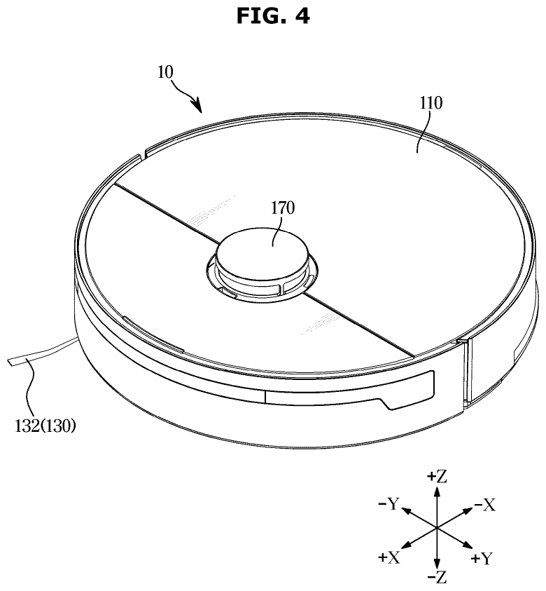

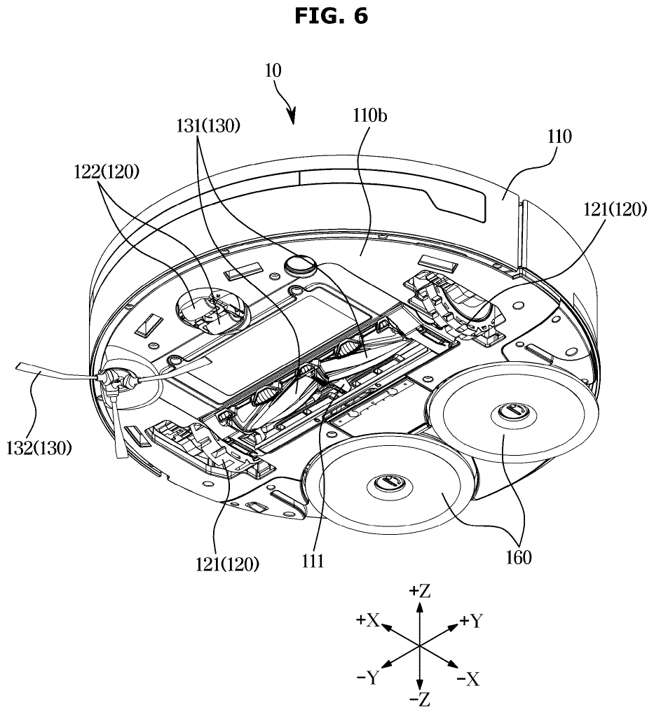

FIG. 4 illustrates a robot cleaner, according to an embodiment of the disclosure. FIG. 5 illustrates the rear of a robot cleaner, according to an embodiment of the disclosure. FIG. 6 illustrates the bottom of a robot cleaner, according to an embodiment of the disclosure.

The robot cleaner 10 may include a main body 110. The main body 110 may define an overall exterior of the robot cleaner 10. The main body 110 may accommodate constituent components of robot cleaner 10. Electronic parts may be arranged in the main body 110. The main body 110 may be referred to as a cleaner body 110.

The robot cleaner 10 may include an intake 111. The intake 111 may be formed to face the surface to be cleaned. The intake 111 may be open to the surface to be cleaned. The intake 111 may be formed at the main body 110. The intake 111 may be formed at the bottom of the main body 110. The intake 111 may be formed to penetrate a bottom surface 110b of the main body 110. Dirt on the surface to be cleaned may be drawn into the main body 110 through the intake 111 along with air. The intake 111 may be referred to as a cleaner intake 111.

The robot cleaner 10 may include a brush 130. The brush 130 may scatter the dirt by striking the surface to be cleaned. The dirt scattered by the brush 130 may flow into the intake 111 along with air.

For example, the robot cleaner 10 may include a first brush 131 arranged at the intake 111. The first brush 131 may be rotationally mounted in relation to the main body 110. The rotational shaft of the first brush 131 may extend in substantially a horizontal direction (the Y direction). The first brush 131 may be referred to as a main brush 131.

For example, the robot cleaner 10 may include a second brush 132 arranged to be adjacent to a bottom edge of the main body 110. The second brush 132 may guide dirt around the main body 110 that the first brush 131 is unable to swipe to the intake 111. The second brush 132 may be rotationally mounted in relation to the main body 110. The rotational shaft of the second brush 132 may extend in substantially a vertical direction (the Z direction). The second brush 132 may be referred to as a side brush 132.

The robot cleaner 10 may include a dust collecting tank 141. The dirt and/or air drawn in through the intake 111 may be moved into the dust collecting tank 141. The dirt drawn in through the intake 111 may be collected into the dust collecting tank 141. The air drawn in through the intake 111 may be filtered while passing the dust collecting tank 141. The dirt and the air drawn in through the intake 111 may be separated in the dust collecting tank 141.

The robot cleaner 10 may include an exhaust port 112. The exhaust port 112 may be formed at the main body 110. The exhaust port 112 may be formed on a rear side of the main body 110. The air drawn in through the intake 111 may be filtered and then discharged out of the robot cleaner 10 through the exhaust port 112. For example, the exhaust port 112 may be provided in the plural, and the plurality of exhaust ports may be formed as a plurality of holes. The exhaust port 112 may be referred to as a cleaner exhaust port 112.

The robot cleaner 10 may include a suction motor 142. The suction motor 142 may generate suction force. The intake 111 may draw in dirt and/or air by the suction force generated by the suction motor 142. By the suction force generated from the suction motor 142, the exhaust port 112 may discharge the air drawn into the robot cleaner 10 and filtered to the outside. The suction motor 142 may be placed in an air flow path formed between the intake 111 and the exhaust port 112. The suction motor 142 may be referred to as a cleaner suction motor 142.

The robot cleaner 10 may include a traveling part 120 for moving the robot cleaner 10. The traveling part 120 may be mounted at the main body 110 to move the main body 110. For example, the traveling part 120 may include a pair of main wheels 121. For example, the traveling part 120 may further include at least one auxiliary wheel 122 for stable traveling of the robot cleaner 10.

The robot cleaner 10 may include a battery 150. The battery 150 may be rechargeable. The battery 150 may supply power required to drive the robot cleaner 10.

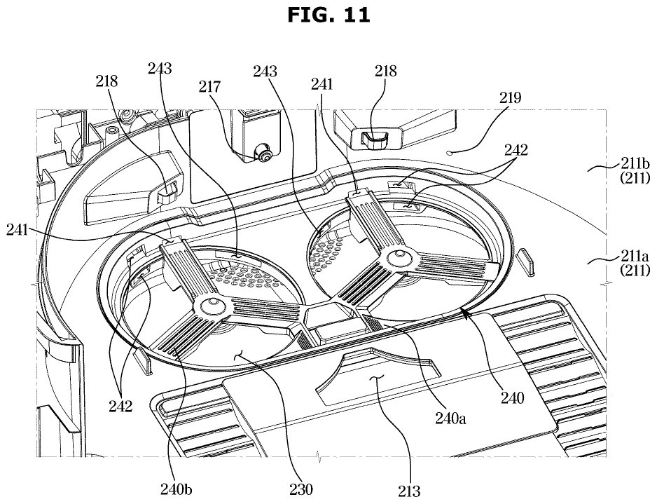

The robot cleaner 10 may include a charging terminal 151. The charging terminal 151 may be electrically connected to the battery 150. While the robot cleaner 10 is settled in the station 20, the charging terminal 151 of the robot cleaner 10 may be electrically connected to a charging terminal 218 (see FIG. 11) of the station 20. As the charging terminal 151 of the robot cleaner 10 is electrically connected to the charging terminal 218 of the station 20, the battery 150 of the robot cleaner 10 may be charged. In other words, the battery 150 may be charged while the robot cleaner 10 is docked in the station 20. The charging terminal 151 may be referred to as a cleaner charging terminal 151.

The robot cleaner 10 may include a wettable cloth 160. The wettable cloth 160 is detachably mounted at the bottom of the main body 110. The wettable cloth 160 may be rotationally mounted on the main body 110. The wettable cloth 160 may be provided to clean the surface to be cleaned by touching the surface to be cleaned. In a state of being wet, the wettable cloth 160 may wipe out dirt on the surface to be cleaned. Although the wettable cloth 10 is shown as being in two, the number of the wettable clothes 160 is not limited thereto. The wettable cloth 160 may be referred to as a cleaner pad 160. The wettable cloth 160 may be referred to as a wet pad 160.

The wettable cloth 160 may receive water from a water tank 114 of the robot cleaner 10. The wettable cloth 160 may receive water from the station 20. For example, when the water content of the wettable cloth 160 decreases while the robot cleaner 10 is cleaning, water stored in the water tank 114 may be provided to the wettable cloth 160. For example, when the water content of the wettable cloth 160 decreases while the robot cleaner 10 is cleaning, the robot cleaner 10 may return to the station 20 and settled in the station 20. In this case, the station 20 may supply water into the water tank 114 or jet water and/or steam toward the wettable cloth 160. The settling of the robot cleaner 10 in the station 20 may include docking of the robot cleaner 10 to the station 20.

The robot cleaner 10 may include a water charger 113. The water charger 113 may be formed in the main body 110. The water charger 113 may be formed on the rear side of the main body 110. While the robot cleaner 10 is settled in the station 20, the water charger 113 may accommodate water provided from the station 20. The water supplied to the robot cleaner 10 through the water charger 113 may be stored in the water tank 114. While the robot cleaner 10 is settled in the station 20, the water charger 113 of the robot cleaner 10 may be docked with a first water supplier 217 (see FIG. 11) of the station 20 as will be described later.

The robot cleaner 10 may include an obstacle detection sensor 170. The obstacle detection sensor 170 may be arranged to detect a location of an obstacle or a distance to the obstacle. The obstacle detection sensor 170 may be mounted on the main body 110. For example, the obstacle detection sensor 170 may protrude from a top surface 110a of the main body 110.

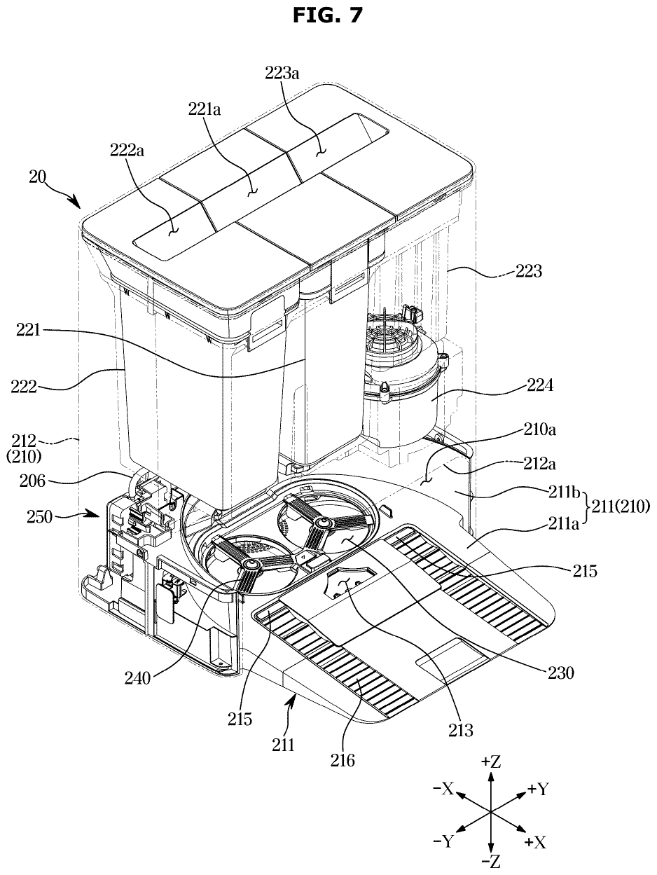

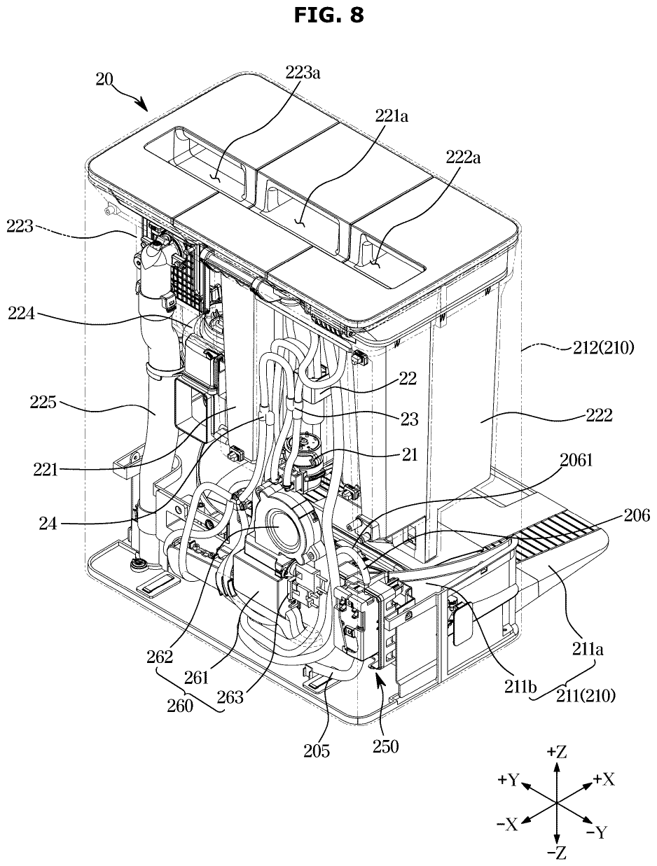

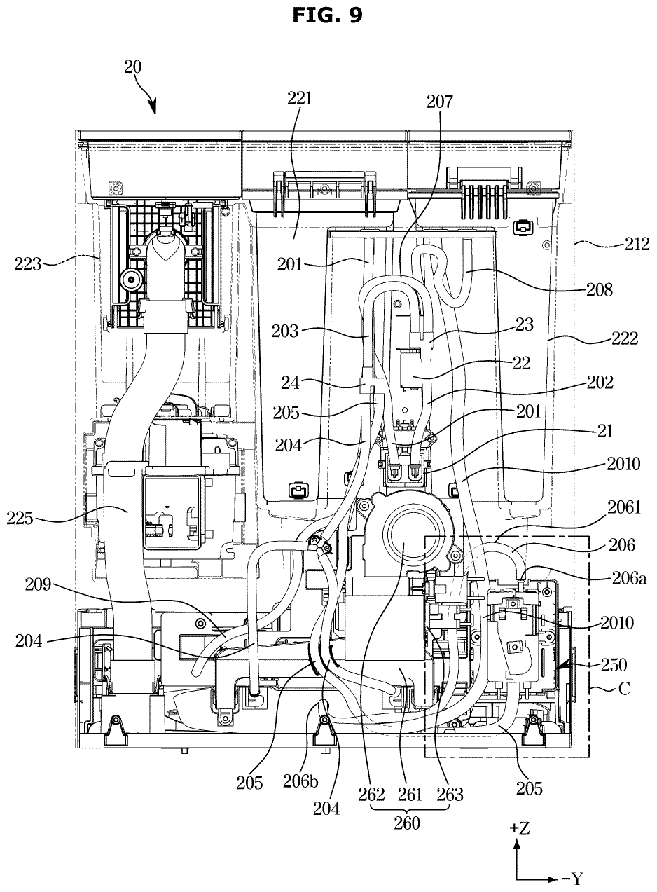

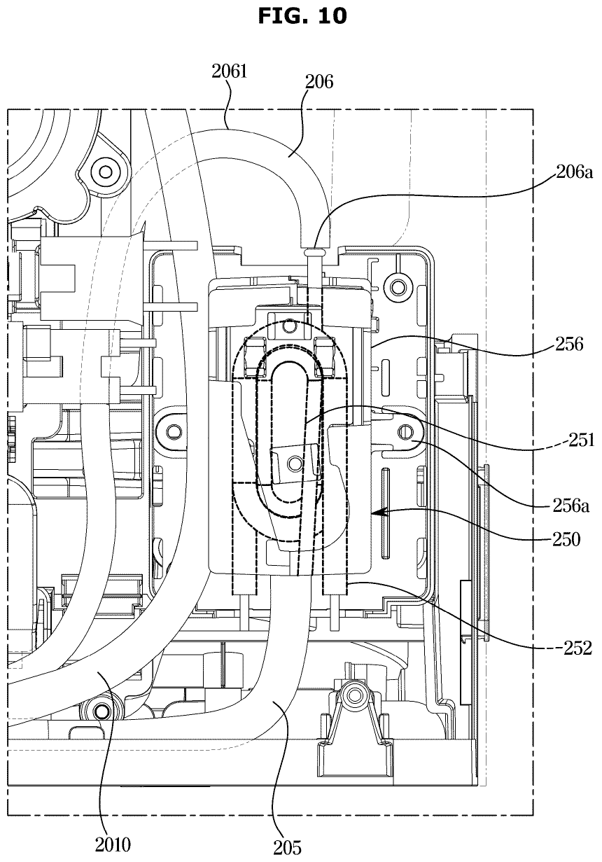

FIG. 7 is a front view of internal components of a station, according to an embodiment of the disclosure. FIG. 8 is a rear view of internal components of a station, according to an embodiment of the disclosure. FIG. 9 is a rear view of an interior of a station, according to an embodiment of the disclosure. FIG. 10 schematically illustrates internal components of a heating device by enlarging portion C shown in FIG. 9.

The station 20 may include a main body 220. The main body 210 may define an overall exterior of the station 20. The main body 210 may define an accommodating space 210a to accommodate at least a portion of the robot cleaner 10. The main body 210 may be referred to as a station body 210.

The main body 210 may include a base 211 and a housing 212 to be detachably coupled to the base 211.

The base 211 may include a cleaner settling part 211a where the robot cleaner 10 is cradled. The cleaner settling part 211a may have a shape sloped from the surface to be cleaned for the robot cleaner 10 to enter. For example, the cleaner settling portion 211a may have the shape of an upward slope in a direction in which the robot cleaner 10 enters the station 20. For example, an anti-slip portion 216 may be formed on the cleaner settling portion 211a for the robot cleaner 10 to easily go up the slope of the cleaner settling portion 211a. For example, an anti-slip bump 215 may be formed on the cleaner settling portion 211a to prevent the robot cleaner 10 settled in the station 20 from sliding down the slope of the cleaner settling portion 211a. The robot cleaner 10 settled in the station 20 may be prevented by the anti-slip bump 215 from falling out of the station 20.

The base 211 may include a side wall 211b extending upward from the cleaner settling portion 211a. The side wall 211b may be arranged to surround at least a portion of the cleaner settling portion 211a.

The housing 212 may be arranged to cover the side wall 211b of the base 211. The housing 212 may accommodate components of the station 20. Electronic parts may be arranged in the housing 212. The housing 212 may define an open portion 212a, and the robot cleaner 10 may enter the receiving space 210a of the station 20 through the open portion 212a.

The station 20 may include a water supply tank 221. The water supply tank 221 may be provided to store water. Relatively clean water may be accommodated in the water supply tank 221. The water stored in the water supply tank 221 may be supplied into the water tank 114 of the robot cleaner 10 or supplied into a washing chamber 230 of the station 20, which will be described later. In other words, the water stored in the water supply tank 221 may provide water to the wettable cloth 160 or may be used to wash the wettable cloth 160. The water supply tank 221 may be detachably mounted in the main body 210. For example, the user may grip a handle 221a of the water supply tank 221 to detach the water supply tank 221 from the main body 210 or attach the water supply tank 221 to the main body 210.

The station 20 may include a wastewater tank 222. The wastewater tank 222 may be provided to store water. Relatively dirty water may be accommodated in the wastewater tank 222. Water (wastewater) soiled by washing the wettable cloth 160 may be stored in the wastewater tank 222. The wastewater tank 222 may be detachably mounted in the main body 210. For example, the user may grip a handle 222a of the wastewater tank 222 to detach the wastewater tank 222 from the main body 210 or attach the wastewater tank 222 to the main body 210.

The station 20 may include a dirt collecting tank dirt collecting. The dirt collecting tank 223 may be arranged to store dirt collected from the dust collecting tank 141 of the robot cleaner 10. The dirt collecting tank 223 may be detachably mounted in the main body 210. For example, the user may grip a handle 223a of the dirt collecting tank 223 to detach the dirt collecting tank 223 from the main body 210 or attach the dirt collecting tank 223 to the main body 210.

Although the wastewater tank 222, the water supply tank 221 and the dirt collecting tank 223 are shown as being arranged side by side in substantially the horizontal direction (the Y direction), the respective positions of the wastewater tank 222, the water supply tank 221 and the dirt collecting tank 223 are not limited thereto.

The station 20 may include an intake 213. The intake 213 may be formed at the cleaner settling portion 211a. While the robot cleaner 10 is settled in the station 20, the intake 213 may be connected to the dust collecting tank 141 of the robot cleaner 10. The intake 213 may be provided to draw in dirt collected in the dust collecting tank 141. The intake 213 may be referred to as a cleaner intake 213.

The station 20 may include a dirt collecting duct 225. The dirt collecting duct 225 may be arranged to guide the dirt drawn in through the intake 213 into the dirt collecting tank 223. The dirt collecting duct 225 may be arranged between the intake 213 and the dirt collecting tank 223. An end of the dirt collecting duct 225 may be connected to the intake 213. The other end of the dirt collecting duct 225 may be connected to the dirt collecting tank 223.

The station 20 may include an exhaust port 214 (see FIG. 3). The exhaust port 214 may be formed on a rear side of the main body 210. The exhaust port 214 may be formed on a rear surface of the housing 212. The exhaust port 214 may discharge air drawn into the station 20 and filtered to the outside. For example, the exhaust port 214 may be provided in the plural, and the plurality of exhaust ports 214 may be formed as a plurality of holes. The exhaust port 214 may be referred to as a station exhaust port 214.

The station 20 may include a suction motor 224. When the robot cleaner 10 is settled in the station 20, the suction motor 224 may generate suction force to draw in the dirt of the dust collecting tank 141. By the suction force of the suction motor 224, the dirt in the dust collecting tank 141 may be moved along the intake 213 and the dirt collecting duct 225 and collected in the dirt collecting tank 223. By the suction force generated by the suction motor 224, the exhaust port 214 may discharge the air drawn into the station 20 and having passed a discharge filter 226 to the outside. The suction motor 224 may be referred to as a station suction motor 224.

The station 20 may include a heating device 250. The heating device 250 may produce hot water and/or steam. The heating device 250 may use the water stored in the water supply tank 221 to produce hot water and/or steam. The heating device 250 may receive the water stored in the water supply tank 221 to produce the hot water and/or steam. For example, the heating device 250 may produce hot water by heating the water to 40° C. or more, or produce steam by heating the water to 100° C. or more.

The hot water and/or steam produced from the heating device 250 may be supplied into the washing chamber 230. For example, the hot water and/or steam produced from the heating device 250 may be supplied to the robot cleaner 10.

The heating device 250 may be arranged farther below than the water supply tank 221. When the water of the water supply tank 221 is supplied to the heating device 250, the first pump 21 may pump the water of the water supply tank 221 at relatively low power with the help of gravity.

Referring to FIG. 10, for example, the heating device 250 may include a water pipe 251 and a heater 252. The heating device 250 may include a heating device case 256 to accommodate at least a portion of the water pipe 251 and at least a portion of the heater 252. The heating device case 256 may include a case mounting part 256a to be mounted in the main body 210 of the station 20.

The water pipe 251 may be arranged to connect a fifth pipe 205 to a sixth pipe 206. The water pipe 251 may form a flow path for the water brought in through the fifth pipe 205 to flow into the sixth pipe 206. For example, the water pipe 251 may extend by being bent several times between the fifth pipe 205 and the sixth pipe 206.

The heater 252 may be arranged to be adjacent to the water pipe 251. The heater 252 may be provided to heat water that has passed the water pipe 251. The heater 252 may extend in a direction in which the water pipe 251 extends. For example, to match the water pipe 251 that extends by being bent several times, the heater 252 may extend by being bent several times. The heater 252 may have a similar shape to the water pipe 251.

In the disclosure, as the water pipe 251 has the shape that is bent several times and the heater 252 also has the shape that is bent several times to match the water pipe 251, the heating device 250 may increase a flow path in which water flows from the fifth pipe 205 to the sixth pipe 206 in a limited space, thereby securing a time for which the heater 252 heats water.

The station 20 may include a drying device 260. The drying device 260 may be arranged to produce air to dry the wettable cloth 160 (hereinafter, referred to as dry air). The drying device 260 may be arranged to provide the dry air to the washing chamber 230 which will be described later. While the robot cleaner 10 is settled in the station 20, the dry air discharged from the drying device 260 may be directed to the wettable cloth 160. The air (dry air) produced and provided from the drying device 260 may have relatively low humidity or high temperature. The dry air may also be referred to as hot wind or dry wind.

For example, after washing and/or sterilizing the wettable cloth 160, the station 20 may provide the dry air to the wettable cloth 160. For example, when the water content of the wettable cloth 160 increases while the wettable cloth 160 is wiping water on the surface to be cleaned during the cleaning of the robot cleaner 10, the robot cleaner 10 may return to the station 20 and the station 20 may discharge dry air toward the wettable cloth 160.

The drying device 260 may include a fan 262 that generates wind blowing force. The drying device 260 may include a drying duct 261 arranged to guide air blown by the fan 262. The drying duct 261 may be arranged to connect the fan 262 to the washing chamber 230 which will be described later. The drying device 260 may include the heater 263 arranged to heat the air blown by the fan 262. The heater 263 may be provided to heat the air guided by the drying duct 261. At least a portion of the heater 263 may be arranged in the dying duct 261.

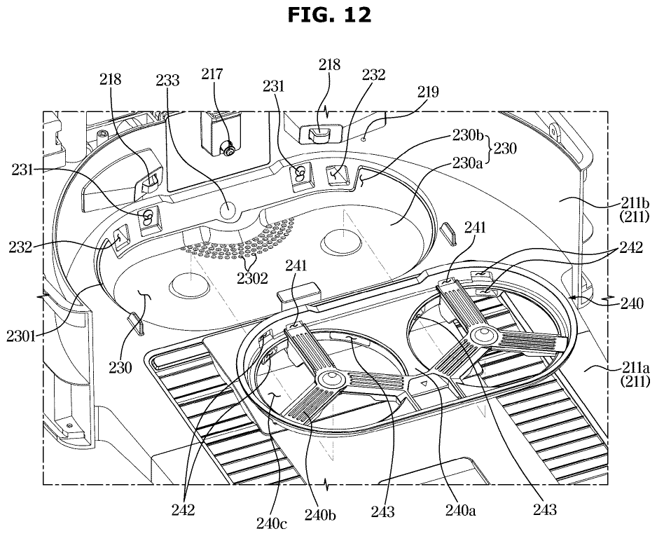

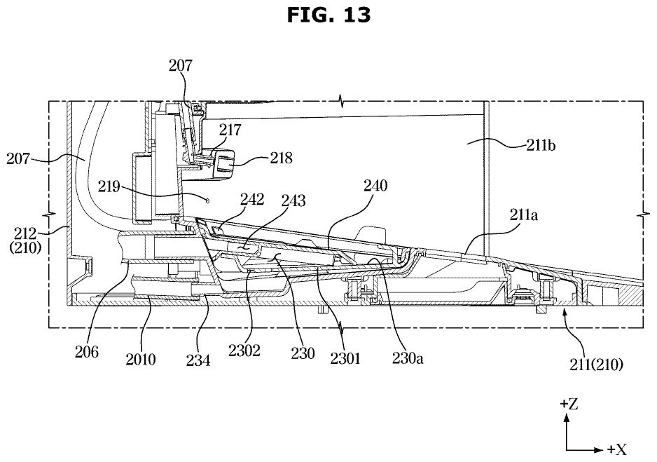

FIG. 11 illustrates a portion of a station, according to an embodiment of the disclosure. FIG. 12 illustrates a state of a washing frame being separated from a washing chamber in a station, according to an embodiment of the disclosure. FIG. 13 is a cross-sectional view of a side of a station, according to an embodiment of the disclosure.

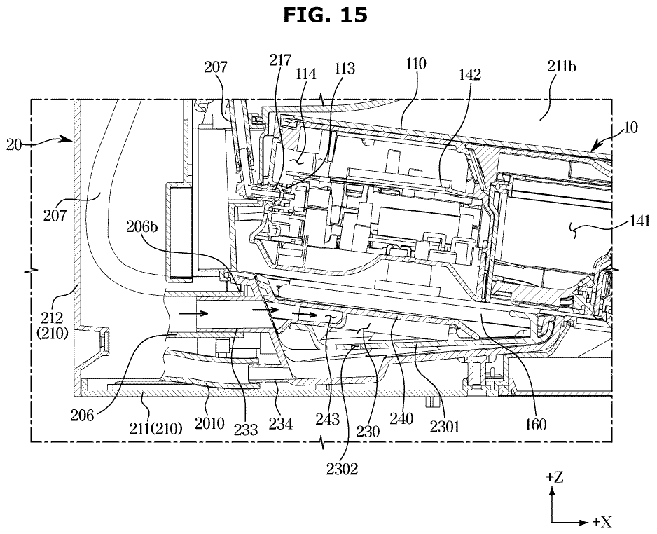

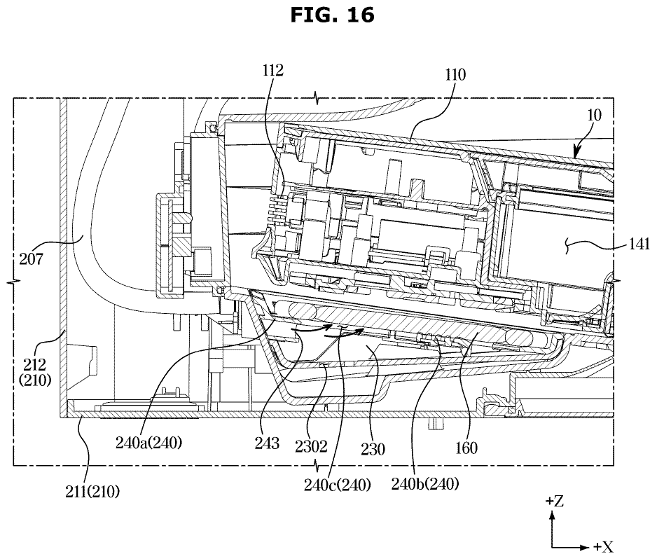

The station 20 may include the washing chamber 230. While the robot cleaner 10 is cradled in the station 20, the washing chamber 230 may be arranged to correspond with the wettable cloth 160 (e.g., the washing chamber 230 may be configured to align with the wettable cloth 160 as shown in FIGS. 15-16). The washing chamber 230 may be defined as a space where the wettable cloth 160 is washed. The washing chamber 230 may be arranged to accommodate water received from the water supply tank 221. The washing chamber 230 may have a shape to contain water. While the robot cleaner 10 is settled in the station 20, the wettable cloth 160 may be washed by the water accommodated in the washing chamber 230.

The washing chamber 230 may be formed in the base 211 of the main body 210. The washing chamber 230 may be arranged to be sunken from the cleaner settling portion 211a. The washing chamber 230 may be defined by a chamber floor 230a and a chamber side wall 230b extending upward from the chamber floor 230a. The chamber side wall 230b may be arranged to have a certain height.

The chamber floor 230a may be sloped downward in a direction in which the robot cleaner 10 enters the station 20. For example, the chamber floor 230a may be sloped downward in the rearward direction. With this, water (wastewater) in the washing chamber 230 may smoothly flow toward a wastewater collector 234 located behind the washing chamber 230 along the slope of the chamber floor 230a after completion of washing of the wettable cloth 160. The disclosure is not, however, limited to what are described above, and the direction of the slope of the chamber floor 230a may vary depending on the location of the wastewater collector 234.

For example, the station 20 may include a tray 2301. The tray 2301 may be detachably mounted on the base 211 of the main body 210 to define at least a portion of the washing chamber 230. For example, the tray 2301 may be arranged to form at least a portion of the chamber floor 230a and the chamber side wall 230b. The tray 2301 may include at least one tray hole 2302. The wastewater in the washing chamber 230 may pass the tray hole 2302 and flow to the wastewater collector 234. As the tray 2301 includes the tray hole 2302, a foreign material bigger than the tray hole 2302 may be filtered off in the tray 2301. In other words, the tray 230 may primarily filter the wastewater after the wettable cloth 160 is washed.

The station 20 may include a washing frame 240. The washing frame 240 may be arranged to match the washing chamber 230. The washing frame 240 is detachably mounted in the washing chamber 230. While the robot cleaner 10 is cradled in the station 20, the washing frame 240 may be arranged to touch the wettable cloth 160. While the robot cleaner 10 is cradled in the station 20, the washing frame 240 may be arranged to rub the wettable cloth 160. The wettable cloth 160 may be washed by being rubbed against the washing frame 240. In this case, the wettable cloth 160 may be rotationally arranged.

For example, the washing frame 240 may include a frame body 240a, a frame projection 240b and a frame opening 240c. The frame body 240a may be detachably coupled with the chamber side wall 230b. The frame opening 240c may be formed to bore through the frame body 240a. The frame projection 240b may be formed at the frame body 240a to interfere with the wettable cloth 160.

The station 20 may include the charging terminal 218. While the robot cleaner 10 is settled in the station 20, the charging terminal 218 of the station 20 may be electrically connected to the charging terminal 151 of the robot cleaner 10. As the charging terminal 218 of the station 20 is electrically connected to the charging terminal 151 of the robot cleaner 10, the battery 150 of the robot cleaner 10 may be charged. In other words, the robot cleaner 10 may be charged while being docked to the station 20. The charging terminal 218 may be referred to as a station charging terminal 218.

The station 20 may include a first water supplier 217. The first water supplier 217 may receive the water stored in the water supply tank 221 and may supply the water to the robot cleaner 10. While the robot cleaner 10 is cradled in the station 20, the first water supplier 217 of the station 20 may be connected to the water charger 217 of the robot cleaner 10. The water flowing out of the first water suppler 217 may flow to the water charger 113. Water brought in through the water charger 113 may be stored in the water tank 114. When the water content of the wettable cloth 160 decreases while the robot cleaner 1 is cleaning, water stored in the water tank 114 may be provided to the wettable cloth 160. For example, the first water supplier 217 may be formed on the side wall 211b of the base 211 of the main body 210.

The station 20 may include a second water supplier 231. The second water supplier 231 may be connected to the washing chamber 230. The second water supplier 231 may receive the water stored in the water supply tank 221 and may supply the water to the washing chamber 230. The water flowing out of the second water suppler 231 may be accommodated in the washing chamber 230. The water flowing out of the second water suppler 231 may be used to wash the wettable cloth 160. Although the second water supplier 231 is shown as being in two, there are no limitations on the number of the second water suppliers 231. For example, the number of the second water suppliers 231 may correspond to the number of wettable clothes 160.

The station 20 may include a water jet port 241. The water jet port 241 may be formed at the washing frame 240. While the washing frame 240 is mounted in the washing chamber 230, the water jet port 241 may correspond with the second water supplier 231. The water jet port 241 may be connected to the second water supplier 231. The water jet port 241 may be connected to the washing chamber 230. The water jet port 241 may receive water from the second water supplier 231 and jet the water toward the washing chamber 230. While the robot cleaner 10 is cradled in the station 20, the water jet port 241 may jet water toward the wettable cloth 160. Although the water jet port 241 is shown as being in two, there are no limitations on the number of wettable clothes 241. For example, the number of water jet ports 241 may correspond to the number of wettable clothes 160.

The station 20 may include a dry air supplier 232. The dry air supplier 232 may be connected to the washing chamber 230. The dry air supplier 232 may receive dry air from the drying device 260 and supply the dry air to the washing chamber 230. The dry air flowing out of the drying device 260 may be supplied to the washing chamber 230 through the dry air supplier 232. Although the dry air supplier 232 is shown as being in two, there are no limitations on the number of the dry air suppliers 232. For example, the number of dry air suppliers 232 may correspond to the number of wettable clothes 160.

The station 20 may include a dry air jet port 242. The dry air jet port 242 may be formed at the washing frame 240. While the washing frame 240 is mounted in the washing chamber 230, the dry air jet port 242 may correspond with the dry air supplier 232. The dry air jet port 242 may be connected to the dry air supplier 232. The dry air jet port 242 may be connected to the washing chamber 230. The dry air jet port 242 may receive dry air from the dry air supplier 232 and jet the dry air toward the washing chamber 230. While the robot cleaner 10 is cradled in the station 20, the dry air jet port 242 may jet dry air toward the wettable cloth 160. Although two of the dry air jet ports 242 arranged vertically are shown as corresponding with one dry air supplier 232, the disclosure is not limited thereto. There are no limitations on the shape and/or position of the dry air jet port 242.

The station 20 may include a washing supplier 233. The washing supplier 233 may be connected to the washing chamber 230. The washing supplier 233 may receive hot water and/or steam from the heating device 250 and supply it to the washing chamber 230. The hot water and/or steam produced from the heating device 250 may flow to the washing chamber 230 through the washing supplier 233. Although the washing supplier 233 is shown as being in one, there are no limitations on the number of washing supplier 233. For example, the washing supplier 233 may be provided in the plural.

The station 20 may include a washing jet port 243. The washing jet port 243 may be formed at the washing frame 240. While the washing frame 240 is mounted in the washing chamber 230, the washing jet port 243 may correspond with the washing supplier 233. The washing jet port 243 may be connected to the washing supplier 233. The washing jet port 243 may be connected to the washing chamber 230. The washing jet port 243 may receive hot water and/or steam from the washing supplier 233 and jet it toward the washing chamber 230. While the robot cleaner 10 is cradled in the station 20, the washing jet port 243 may jet hot water and/or steam toward the wettable cloth 160. Although the washing jet port 243 is shown as being in two, there are no limitations on the number of washing jet ports 243. For example, the number of washing jet ports 243 may correspond to the number of wettable clothes 160.

The station 20 may include the wastewater collector 234. The wastewater collector 234 may be connected to the washing chamber 230. The wastewater collector 234 may be arranged to collect wastewater in the washing chamber 230. The wastewater collector 234 may be arranged to guide the wastewater in the washing chamber 230.

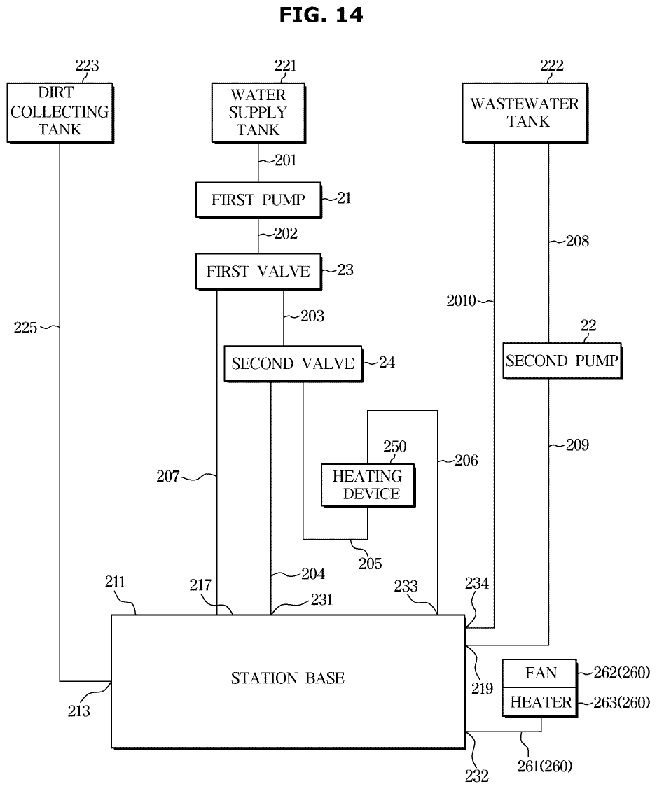

FIG. 14 schematically illustrates some components of a station, according to an embodiment.

Referring to FIG. 14, the station 20 may include at least one pipe 201, 202, 203, 204, 205, 206, 207, 208, 209 and/or 2010. The station 20 may include at least one pump 21 and/or 22. The station 20 may include at least one valve 23 and/or 24.

The station 20 may include the first pipe 201. The first pipe 201 may be arranged to connect the water supply tank 221 to the first pump 21. An end of the first pipe 201 may be connected to the water supply tank 221. The other end of the first pipe 201 may be connected to the first pump 21. The first pipe 201 may be arranged to guide the water flowing out of the water supply tank 221 or the water flowing out of the first pump 21. Water may flow along a first flow path formed in the first pipe 201.

The station 20 may include the second pipe 202. The second pipe 202 may be arranged to connect the first pump 21 to the first valve 23. An end of the second pipe 202 may be connected to the first pump 21. The other end of the second pipe 202 may be connected to the first valve 23. The second pipe 202 may be arranged for the water pumped by the first pump 21 to flow. The second pipe 202 may be arranged to guide the water flowing out of the first pump 21 or the water flowing out of the first valve 23. Water may flow along a second flow path formed in the second pipe 202.

The station 20 may include the third pipe 203. The third pipe 203 may be arranged to connect the first valve 23 to the second valve 24. The third pipe 203 may be arranged between the first pump 21 and the second valve 24. The third pipe 203 may be arranged between the first valve 23 and the second valve 24. An end of the third pipe 203 may be connected to the first valve 23. The other end of the third pipe 203 may be connected to the second valve 24. The third pipe 203 may be arranged for the water pumped by the first pump 21 to flow. The third pipe 203 may be arranged to guide the water flowing out of the first valve 23 or the water flowing out of the second valve 24. Water may flow along a third flow path formed in the third pipe 203.

The station 20 may include the fourth pipe 204. The fourth pipe 204 may be arranged to connect the second valve 24 to the base 211. The fourth pipe 204 may be arranged to connect the second valve 24 to the second water supplier 231. An end of the fourth pipe 204 may be connected to the second valve 24. The other end of the fourth pipe 204 may be connected to the second water supplier 231. The other end of the fourth pipe 204 may be connected to the washing chamber 230. The fourth pipe 204 may be arranged to guide water flowing from the second valve 24. The fourth pipe 204 may be arranged to guide the water pumped by the first pump 21 to the washing chamber 230. Water may flow along a fourth flow path formed in the fourth pipe 204.

The station 20 may include the fifth pipe 205. The fifth pipe 205 may be arranged to connect the second valve 24 to the heating device 250. An end of the fifth pipe 205 may be connected to the second valve 24. The other end of the fifth pipe 205 may be connected to the heating device 250. The fifth pipe 205 may be arranged to guide the water flowing out of the second valve 24 or the water flowing out of the heating device 250. The fifth pipe 205 may be arranged to guide the water pumped by the first pump 21 to the heating device 250. Accordingly, the water stored in the water supply tank 221 may be guided by the fifth pipe 205 to flow to the heating device 250. Alternatively, the fifth pipe 205 may be arranged to guide the water pumped by the first pump 21 to the second valve 24 from the heating device 250. Accordingly, the water of the heating device 250 may be guided by the fifth pipe 205 to flow to the second valve 24. Water may flow along a fifth flow path formed in the fifth pipe 205.

For example, the fifth pipe 205 may be connected to the bottom of the heating device 250.

The station 20 may include the sixth pipe 206. The sixth pipe 206 may be arranged to connect the heating device 250 to the base 211. The sixth pipe 206 may be arranged to connect the heating device 250 to the washing supplier 233. An end 206a (see FIG. 9) of the sixth pipe 206 may be connected to the heating device 250. The other end 206b (see FIG. 9) of the sixth pipe 206 may be connected to the washing supplier 233. The other end 206b of the sixth pipe 206 may be connected to the washing chamber 230. The sixth pipe 206 may be arranged to guide hot water and/or steam produced from the heating device 250. The sixth pipe 206 may be arranged to guide hot water and/or steam produced from the heating device 250 to the washing chamber 230. Hot water and/or steam may flow along a sixth flow path formed in the sixth pipe 206.

For example, the sixth pipe 206 may be connected to the top of the heating device 250. In general, considering that the density of steam lower than that of the air moves upward, the sixth pipe 206 may be connected to the top of the heating device 250.

For example, the sixth pipe 206 may include a bending portion 2061 (see FIG. 9) windingly arranged in a vertical space between the heating device 250 and the water supply tank 221. With this, the water and/or dirt in the washing chamber 230 may be prevented from flowing backward.

Although not shown, the station 20 may further include a pipe to guide the hot water and/or steam produced from the heating device 250 to the first water supplier 217. For example, the hot water and/or steam produced from the heating device 250 may be guided to the first water supplier 217 to be supplied to the robot cleaner 10.

The station 20 may include the seventh pipe 207. The seventh pipe 207 may be arranged to connect the first valve 23 to the base 211. The seventh pipe 207 may be arranged to connect the first valve 23 to the first water supplier 217. An end of the seventh pipe 207 may be connected to the first valve 23. The other end of the seventh pipe 207 may be connected to the first water supplier 217. The seventh pipe 207 may be arranged to guide water flowing out of the first valve 23. The seventh pipe 207 may be arranged to guide the water flowing in the second pipe 202 to the robot cleaner 10 cradled in the station 20. Water may flow along a seventh flow path formed in the seventh pipe 207.

The station 20 may include the eighth pipe 208. The eighth pipe 208 may be arranged to connect the wastewater tank 222 to the second pump 22. An end of the eighth pipe 208 may be connected to the wastewater tank 222. The other end of the eighth pipe 208 may be connected to the second pump 22. The eighth pipe 208 may be arranged to guide air flowing out of the wastewater tank 222. Air may flow along an eighth flow path formed in the eighth pipe 208.

The station 20 may include the ninth pipe 209. The ninth pipe 209 may be arranged to connect the second pump 22 to the base 211. The ninth pipe 209 may be arranged to connect the second pump 22 to an air discharge hole 219 (see FIGS. 11 to 13). An end of the ninth pipe 209 may be connected to the second pump 22. The other end of the ninth pipe 209 may be connected to the outside through the air discharge hole 219. The ninth pipe 209 may be arranged to guide the air pumped by the second pump 22. Air may flow along a ninth flow path formed in the ninth pipe 209.

The station 20 may include the tenth pipe 2010. The tenth pipe 2010 may be arranged to connect the wastewater tank 222 to the base 211. The tenth pipe 2010 may be arranged to connect the wastewater tank 222 to the wastewater collector 234. An end of the tenth pipe 2010 may be connected to the wastewater tank 222. The other end of the tenth pipe 2010 may be connected to the wastewater collector 234. The other end of the tenth pipe 2010 may be connected to the washing chamber 230. The tenth pipe 2010 may be arranged to guide the wastewater of the washing chamber 230. The wastewater may flow along a tenth flow path formed in the tenth pipe 2010.

The station 20 may include a dirt collecting duct 225. The dirt collecting duct 225 may be arranged to connect the dirt collecting tank 223 to the base 211. The dirt collecting duct 225 may be arranged to connect the dirt collecting tank 223 to the intake 213. An end of the dirt collecting duct 225 may be connected to the dirt collecting tank 223. The other end of the dirt collecting duct 225 may be connected to the intake 213. The dirt collecting duct 225 may be arranged to guide dirt and/or air. The dirt collecting duct 225 may be referred to as an eleventh pipe 225. The dirt and/or air may flow along an eleventh flow path formed in the eleventh pipe 225.

The station 20 may include a dry duct 261. The dry duct 261 may be arranged to guide dry air. The dry duct 261 may be arranged to guide air blown by the fan 262 and heated by the heater 263 to the base 211. The dry duct 261 may be connected to the base 211. The dry duct 261 may be connected to the dry air supplier 232. The dry duct 261 may be connected to the washing chamber 230 through the dry air supplier 232. The dry duct 261 may be referred to as a twelfth pipe 261. Dry air may flow along a twelfth flow path formed in the twelfth pipe 261.

The modifiers ‘first’, ‘second’, ‘third’, ‘fourth’, ‘fifth’, ‘sixth’, ‘seventh’, ‘eighth’, ‘ninth’, ‘tenth’, ‘eleventh’ and ‘twelfth’ of the terms first pipe 201, second pipe 202, third pipe 203, fourth pipe 204, fifth pipe 205, sixth pipe 206, seventh pipe 207, eighth pipe 208, ninth pipe 209, tenth pipe 2010, eleventh pipe 2011 and twelfth pipe 2012 do not limit the components. For example, the fourth pipe 204 may be referred to as a first pipe 204 and the fifth pipe 205 may be referred to as a second pipe 205.

The station 20 may include the first pump 21. The first pump 21 may be connected to the water supply tank 221. The first pump 21 may be connected to the water supply tank 221 through the first pipe 201. The first pump 21 may be connected to the first valve 23. The first pump 21 may be connected to the first valve 23 through the second pipe 202. The first pump 21 may be arranged between the water supply tank 221 and the first valve 23.

The first pump 21 may be arranged to pump the water stored in the water supply tank 221. The first pump 21 may be arranged to pump the water of the heating device 250. For example, power to move the water may be generated when an internal component (e.g., a piston, a rotor or an impeller) of the first pump 21 is rotated. For example, when the internal component of the first pump 21 is rotated in a first direction, water stored in the water supply tank 221 may be pumped, and when the internal component of the first pump 21 is rotated in a second direction that is opposite to the first direction, water of the heating device 250 may be pumped out.

The station 20 may include the second pump 22. The second pump 22 may be connected to the wastewater tank 222. The second pump 22 may be connected to the wastewater tank 222 through the eighth pipe 208. The second pump 22 may be connected to the air discharge hole 219. The second pump 22 may be connected to the air discharge hole 219 through the ninth pipe 209. The second pump 22 may be arranged between the wastewater tank 222 and the base 211.

The second pump 22 may be arranged to pump the air of the wastewater tank 222. The air in the wastewater tank 222 may be discharged from the wastewater tank 222 by the second pump 22.

In the meantime, the modifiers ‘first’ and ‘second’ of the terms first pump 21 and the second pump 22 do not limit the components. For example, the first pump 21 may be referred to as a second pump 21 and the second pump 22 may be referred to as a first pump 22.

The station 20 may include the first valve 23. The first valve 23 may be connected to the second pipe 202. The first valve 23 may be connected to the seventh pipe 207. The first valve 23 may be connected to the third pipe 203.

The first valve 23 may connect the second pipe 202 to the seventh pipe 207 or connect the second pipe 202 to the third pipe 203. The first valve 23 may be arranged to control the flow of water pumped by the first pump 21. The first valve 23 may allow the water pumped by the first pump 21 to flow to the first water supplier 217 or the second valve 24. For example, the first valve 23 may selectively open the seventh pipe 207 and the third pipe 203.

The station 20 may include the second valve 24. The second valve 24 may be connected to the third pipe 203. The second valve 24 may be connected to the fourth pipe 204. The second valve 24 may be connected to the fifth pipe 205.

The second valve 24 may connect the third pipe 203 to the fourth pipe 204 or connect the third pipe 203 to the fifth pipe 205. The second valve 24 may be arranged to control the flow of water guided by the third pipe 203. The second valve 24 may allow the water guided by the third pipe 203 to flow to the second water supplier 231 or the heating device 250. For example, the second valve 24 may selectively open the fourth pipe 204 and the fifth pipe 205.

In the meantime, the modifiers ‘first’ and ‘second’ of the terms first valve 23 and the second valve 24 do not limit the components. For example, the first valve 23 may be referred to as a second valve 23 and the second valve 24 may be referred to as a first valve 24.

FIG. 15 illustrates a cross-section along line A-A′ marked in FIG. 3. FIG. 16 is a cross-section along line B-B′ marked in FIG. 3.

Referring to FIGS. 15 and 16, the robot cleaner 10 may be cradled in the station 20. While the robot cleaner 10 is cradled in the station 20, the wettable cloth 160 may be arranged to correspond with the washing chamber 230 of the station 20 (e.g., the washing chamber 230 may be configured to align with the wettable cloth 160 as shown in FIGS. 15-16). While the robot cleaner 10 is cradled in the station 20, the wettable cloth 160 may be sterilized by hot water and/or steam released from the station 20. The wettable cloth 160 may be arranged to rotate against the main body 110 while being sterilized by the hot water and/or steam. Accordingly, the hot water and/or steam may reach the wettable cloth 160 as a whole.

The sixth pipe 206 may be arranged to guide hot water and/or steam produced from the heating device 250 to the washing chamber 230. An end 206a of the sixth pipe 206 may be connected to the heating device 250 (see FIG. 9) and the other end 206b of the sixth pipe 233 may be connected to the washing supplier 233. The sixth pipe 206 may be connected to the washing chamber 230.

The washing frame 240 is detachably mounted in the washing chamber 230. The washing jet port 243 of the washing frame 240 may be arranged to match the washing supplier 233. The washing jet port 243 may be arranged to jet hot water and/or steam guided to the washing chamber 230 through the sixth pipe 206 toward the wettable cloth 260.

For example, while the robot cleaner 10 is cradled in the station 20, at least a portion of the washing jet port 243 may be arranged farther below than the bottom surface of the wettable cloth 160. The hot water and/or steam jetted from the washing jet port 243 may reach the bottom surface of the wettable cloth 160. At least a portion of the hot water and/or steam jetted from the washing jet port 253 may be moved upward, reaching the bottom surface of the wettable cloth 160. Accordingly, the hot water and/or steam may be intensively jetted to the bottom surface of the wettable cloth 160 that directly touches the surface to be cleaned. In other words, the hot water and/or steam may be intensively supplied to the bottom surface of the wettable cloth 160 that needs sterilization the most.

For example, the size of the other end 206b of the sixth pipe 206 may be set to be larger than the size of the washing jet port 243. For example, the vertical width (in the Z direction) of the other end 206b of the sixth pipe 206 may be set to be larger than the vertical width of the washing jet port 243. As such, as the hot water and/or steam flows from the sixth pipe 206 to the washing jet port 243 of a size relatively smaller than the sixth pipe 206, the velocity of the hot water and/or steam may increase. Accordingly, the hot water and/or steam may be discharged through the washing jet port 243 at a relatively high speed and jetted farther. The hot water and/or steam jetted through the washing jet port 243 may easily reach the wettable cloth 160.

In general, the wettable cloth of the robot cleaner holds water, which makes it easy to multiply germ. When the germ grows in the dirty wettable cloth, the wettable cloth may smell bad and the surface to be cleaned may be contaminated subsequently by the wettable cloth. Furthermore, the germ that grows in the wettable cloth may also affect the user's respiratory health and the user may feel unpleasant. Hence, cleaning efficiency and use convenience of the cleaning device may decrease.

On the other hand, according to the disclosure, the station 20 may jet hot water and/or steam to sterilize the wettable cloth 160 of the robot cleaner 10. The hot water and/or steam may prevent multiplication of germ in the wettable cloth 160. Accordingly, odor occurrence and subsequent contamination of the wettable cloth 160 may be prevented. As the wettable cloth 160 may be kept clean, it is easy to manage the wettable cloth 160. Furthermore, when the water content of the wettable cloth 160 becomes low while the robot cleaner 10 is cleaning, the robot cleaner 10 may return to the station 20 and the station 20 may jet hot water and/or steam toward the wettable cloth 160 of the robot cleaner 10. The hot water and/or steam may be used not only to sterilize the wettable cloth 160 but also to supply moisture to the wettable cloth 160. For example, when a cleaning area is small, the station 20 may jet hot water and/or steam to the wettable cloth 160. Accordingly, the wettable cloth 160 may receive water easily and quickly. As a result, cleaning efficiency and use convenience of the cleaning device 1 may increase.

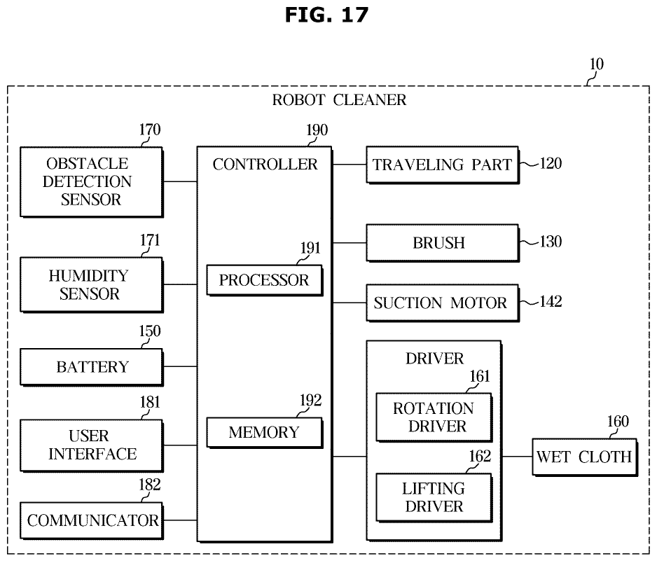

FIG. 17 is a control block diagram of a robot cleaner, according to an embodiment.

Referring to FIG. 17, the robot cleaner 10 according to an embodiment may include an obstacle detection sensor 170, a humidity sensor 171, the battery 150, a user interface 181, the traveling part 120, a brush motor 133, a suction motor 142, a driver 163, a communicator 182 and/or a controller 190.

The obstacle detection sensor 170 detects an obstacle that gets in the way of the robot cleaner 10 to travel. The obstacle may refer to any object that protrudes from the floor of the cleaning area and interrupts traveling of the robot cleaner 10. For example, not only the furniture such as a table, a sofa, etc., located in the cleaning area but also a wall that divides the space may correspond to the obstacle, and an object such as a door sill or a round bar that the cleaning robot 10 may climb up and down may also correspond to the obstacle.

Specifically, the obstacle detection sensor 170 may use electromagnetic waves such as infrared, visible light or ultrasound to detect the obstacle in a non-contact manner. For example, the obstacle detection sensor 170 may irradiate infrared rays and detect infrared rays reflected from the obstacle, and output an intensity of the detected infrared rays or time of flight (ToF) from the irradiating of the infrared rays to the detecting of the reflected infrared rays to the controller 190.

The controller 190 may determine whether there is an obstacle or calculate a distance between the obstacle and the robot cleaner 10 based on the output value of the obstacle detection sensor 170.

In another example, the obstacle detection sensor 170 may include a transmitter for irradiating electromagnetic waves and a receiver for receiving electromagnetic waves reflected from an obstacle.

The transmitter may be arranged on the front of the main body 110 of the robot cleaner 10 to transmit electromagnetic waves in the forward direction from the main body 110. Furthermore, in an embodiment, the transmitter may include an LED that generates electromagnetic waves and a wide-angle lens that diffuses electromagnetic waves in all directions by refracting the transmitted electromagnetic waves.

In another example, the obstacle detection sensor 170 may include a camera for obtaining an image of the vicinity of (e.g., front, back and/or side to) the robot cleaner 10.

The controller 190 may determine whether there is an obstacle or calculate a distance between the obstacle and the robot cleaner 10 based on the image obtained by the obstacle detection sensor 170.

The humidity sensor 171 may include at least one sensor for measuring humidity (or water content) of the wettable cloth 160.

In an embodiment, the humidity sensor 171 may measure a change in moisture in the air. The humidity sensor 171 may be arranged around the wettable cloth 160 to measure humidity (or water content) of the wettable cloth 160. In this case, output humidity of the humidity sensor 171 may be proportional to the water content of the wettable cloth 160.

The controller 190 may determine the humidity (or water content) of the wettable cloth 160 based on the humidity measured by the humidity sensor 171.

In an embodiment, the humidity sensor 171 may measure an intensity of electromagnetic waves reflected from the wettable cloth 160 after irradiating light such as infrared rays, visible rays, etc., or electromagnetic waves such as ultrasound to the wettable cloth 160 and/or a time interval from the irradiating of the electromagnetic waves to the detecting of the reflected electromagnetic waves.

For example, the humidity sensor 171 may include a light emitter for emitting light to the wettable cloth 160 and a photo receiver for receiving light reflected from the wettable cloth 160.

The controller 190 may determine the humidity (or water content) of the wettable cloth 160 based on the output value of the humidity sensor 171.

The controller 190 may perform various operations depending on the humidity (or water content) of the wettable cloth 160. For example, the controller 190 may control the traveling part 120 so that the robot cleaner 10 returns to the station 20 based on the humidity of the wettable cloth 160 being measured to be a predetermined maximum humidity or higher. In another example, the controller 190 may control the traveling part 120 so that the robot cleaner 10 returns to the station 20 based on the humidity of the wettable cloth 160 being measured to be a predetermined minimum humidity or lower.

The battery 150 may supply power to various electric parts of the robot cleaner 10. The battery 150 may be charged while the robot cleaner 10 is settled in the station 20.

The robot cleaner 10 may include a battery sensor for detecting a charge level of the battery 150.

The controller 190 may control the traveling part 120 so that the robot cleaner 10 returns to the station 20 when the charge level of the battery 150 drops below a predetermined charge level.

The user interface 181 may include an output interface and an input interface.

The at least one output interface may send various information relating to the operation of the robot cleaner 10 to the user by generating sensory information.

For example, the at least one output interface may deliver information relating to the settings of the robot cleaner 10 and an operation time of the robot cleaner 10 to the user. The information relating to the operation of the robot cleaner 10 may be output through a display, an indicator and/or voice. The at least one output interface may include, for example, a liquid crystal display (LCD) panel, an indicator, a light emitting diode (LED) panel, a speaker, etc.

In a case that the display includes a touch screen display, the touch screen display may correspond to an example of the output interface and the input interface.

In an embodiment, the at least one output interface may output sensory information (e.g., visual information, auditory information, etc.) relating to control of the robot cleaner 10.

The at least one input interface may convert sensory information received from the user into an electric signal.

The at least one input interface may include a power button to power on the robot cleaner 10.

Each button may include a visual indicator (e.g., text, an icon, etc.) that may indicate the function.

The at least one input interface may include, for example, a tact switch, a push switch, a slide switch, a toggle switch, a micro switch, a touch switch, a touch pad, a touch screen, a jog dial and/or a microphone.

In the disclosure, the button may be replaced by a user interface (UI) element, a tact switch, a push switch, a slide switch, a toggle switch, a micro switch, a touch switch, a touch pad, a touch screen, a jog dial, and/or a microphone.

The robot cleaner 10 may process the user input received through the user interface 181, and output information relating to the robot cleaner 10 through the user interface 181.

In an embodiment, the user interface 181 may include an input interface for receiving a wettable cloth wash command and/or a wettable cloth steam command.

When the user determines that the wettable cloth 160 of the robot cleaner 10 needs to be washed or sterilized, the user may input the wettable cloth wash command and/or the wettable cloth steam command through the input interface.

The robot cleaner 10 may return to the station 20 when receiving the water cloth wash command and/or the wettable cloth steam command through the input interface.

The robot cleaner 10 may transmit a wettable cloth wash request signal and/or a wettable cloth steam request signal to the station 20 when receiving the wettable cloth wash command and/or the wettable cloth steam command through the input interface.

Hence, when the robot cleaner 10 returns to the station 20 and is docked to the station 20 later, the station 20 may perform a washing process and/or a steaming process.

The traveling part 120 may include traveling wheels 121 and 122 arranged at the main body 110 and a wheel motor for providing power to the driving wheels 121 and 122.

The traveling wheels 121 and 122 may rotate to move the main body 110. In this case, with rotation of the traveling wheel 122, the main body 110 may move forward, move rearward, or rotate. For example, when both the left and right traveling wheels 121 and 122 rotate forward, the main body 110 may make a forward rectilinear motion, and when both the left and right traveling wheels 121 and 122 rotate rearward, the main body 110 may make a rearward rectilinear motion.

Furthermore, when the left and right traveling wheels 121 and 122 rotate in the same direction at different speeds, the main body 110 may make a curvilinear motion to the left or right, and when the left and right traveling wheels 121 and 122 rotate in different directions, the main body 110 may rotate to the left or right at the same place.

The wheel motor may generate rotational force to rotate the traveling wheels 121 and 122. A direct current (DC) motor or a brushless DC (BLDC) motor may be employed as the wheel motor, but there are no limitations on the type of the wheel motor. The same is true of other motors included in the robot cleaner 10 in addition to the wheel motor.

The wheel motor may include a left wheel motor for rotating the left traveling wheel and a right wheel motor for rotating the right traveling wheel.

The left and right wheel motors may operate separately from each other according to the control signal from the controller 190, and the main body 110 may move forward, move rearward or rotate according to operations of the left and right wheel motors.

The controller 190 may control the movement of the robot cleaner 10 by controlling the traveling part 120 (e.g., the wheel motor).

Th brush motor 133 may rotate the brush 130.

The controller 190 may control the brush motor 133 to rotate the brush 130 during dry cleaning so that debris on the floor may be scattered by the brush 130.

The suction motor 142 may draw the debris scattered by the brush 130 into the dust collecting tank 141, and rotate a suction fan that generates suction force to draw the debris into the dust collecting tank 141.

The controller 190 may control the suction motor 142 to rotate the suction fan during the dry cleaning so that the debris scattered by the brush 130 is brought into the dust collecting tank 141 through the intake 111.

The driver 163 may include a rotation driver 161 for rotating the wettable cloth 160 and/or a lifting driver 162 for lifting or lowering the wettable cloth 160.

The robot cleaner 10 may include the rotation driver 161 for rotating the wettable cloth 160. The rotation driver 161 may include a motor. The rotation driver 161 may be referred to as a motor 161. For example, while the robot cleaner 10 is mounted on the station 20 and the wettable cloth 160 is being washed and/or sterilized, the motor 161 may rotate the wettable cloth 160. The controller 190 of the robot cleaner 10 may control the motor 161 to rotate the wettable cloth 160.

The controller 190 may control the rotation driver 161 to rotate the wettable cloth 160. The rotation driver 161 may include a motor for rotating the wettable cloth 160 and a driving circuit for driving the motor.

The robot cleaner 10 may include the lifting driver 162 for vertically moving the wettable cloth 160. While the robot cleaner 10 is cleaning, the lifting driver 162 may move the wettable cloth 160 downward. Accordingly, the wettable cloth 160 may touch the surface to be cleaned. While the robot cleaner 10 is returning to the station 20 after completion of cleaning, the lifting driver 162 may move the wettable cloth 160 upward. Accordingly, the wettable cloth 160 may be separated from the surface to be cleaned. This may prevent the wettable cloth 160 from hitting an obstacle on the surface to be cleaned or leaving unnecessary water on the surface to be cleaned while the robot cleaner 10 is moving to the station 20. As will be described later, the controller 190 of the robot cleaner 10 may control the lifting driver 162 to move the wettable cloth 160 vertically.

The controller 190 may control the lifting driver 162 to lift or lower the wettable cloth 160. In other words, the controller 190 may control the lifting driver 162 to move the wettable cloth 160. The lifting driver 162 may include an actuator for moving the wettable cloth 160.

The communicator 182 may communicate with an external device (e.g., a server, a user equipment or the station 20) on the wire and/or wirelessly.

The communicator 182 may transmit or receive data to or from an external device (e.g., a server, a user equipment or the station 20). For this, the communicator 182 may support establishment of a direct (e.g., wired) communication channel or a wireless communication channel between external devices, and communication through the established communication channel. In an embodiment, the communicator 182 may include a wireless communication module (e.g., a cellular communication module, a short-range wireless communication module or a global navigation satellite system (GNSS) communication module) or a wired communication module (e.g., a local area network (LAN) communication module or a power-line communication module). A corresponding one of the communication modules may communicate with an external device over a first network (e.g., a short-range communication network such as bluetooth, Wi-Fi direct or IrDA) or a second network (e.g., a remote communication network such as a legacy cellular network, a 5G network, a next generation communication network, the Internet, or a computer network (e.g., a LAN or WAN). These various types of communication modules may be integrated into a single component (e.g., a single chip) or implemented as a plurality of separate components (e.g., a plurality of chips).

The short-range communication module may include a bluetooth communication module, a BLE communication module, an NFC module, a WLAN, e.g., Wi-Fi, communication module, a Zigbee communication module, an IrDA communication module, a WFD communication module, an UWB communication module, an Ant+ communication module, a uWave communication module, etc., without being limited thereto.

The long-range communication module may include a communication module for performing various types of long-range communication and include a mobile communication interface. The mobile communication interface transmits and receives RF signals to and from at least one of a base station, an external terminal, or a server in a mobile communication network.

In an embodiment, the communicator 182 may communicate with the external device through a nearby access point (AP). The AP may connect a local area network (LAN) connected to the robot cleaner 10 to a wide area network (WAN) connected to the server. The robot cleaner 10 may be connected to the server through the WAN.

In an embodiment, the communicator 182 may communicate with the station 20 wirelessly.

The controller 190 may control general operation of the robot cleaner 10.

The controller 190 may include at least one processor 191 for controlling operation of the robot cleaner 10, and at least one memory 192 for storing a program and data for controlling the operation of the robot cleaner 10.

The at least one processor 191 controls general operation of the robot cleaner 10. Specifically, the at least one processor 191 may be connected to the respective components of the robot cleaner 10 to control general operation of the robot cleaner 10. For example, the at least one processor 191 may be electrically connected to the memory 192 to control general operation of the robot cleaner 10. The processor 191 may include one or more processors.

The at least one processor 191 may execute at least one instruction stored in the memory 192 to perform operation of the robot cleaner 10 according to various embodiments.

The at least one memory 192 may store data required for various embodiments. The memory 192 may be implemented in the form of a memory embedded in or detachable from the robot cleaner 10 depending on the data storage use. For example, data for operating the robot cleaner 10 may be stored in the memory embedded in the robot cleaner 10 and data for an extended function of the robot cleaner 10 may be stored in the memory detachable from the robot cleaner 10. In the meantime, the memory embedded in the robot cleaner 10 may be implemented with at least one of a volatile memory (e.g., a dynamic random access memory (DRAM), a static RAM (SRAM), or a synchronous dynamic RAM (SDRAM), etc.) or a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive or a solid state drive (SSD)). The memory detachable from the robot cleaner 10 may be implemented in such a format as a memory card (e.g., compact flash (CF), secure digital (SD), micro-SD, mini-SD, extreme digital (xD), multi-media card (MMC), etc.) or an external memory (e.g., USB memory) connectable to a USB port.

The at least one processor 191 may include one or more of a central processing unit (CPU), a graphics processing unit (GPU), an accelerated processing unit (APU), a many integrated core (MIC), a digital signal processor (DSP), a neural processing unit (NPU), a hardware accelerator or a machine learning accelerator. The at least one processor 191 may control one or any combination of other components of the robot cleaner 10, and perform a communication related operation or data processing. The at least one processor 191 may execute at least one program or instruction stored in the memory 192. For example, the at least one processor 191 may execute the at least one instruction stored in the memory 192 to perform a method according to at least one embodiment of the disclosure.

In an embodiment, the controller may control the driver 163 according to a predetermined condition. The controlling of the driver 163 may include rotating or moving the wettable cloth 160.

In an embodiment, the controller may control the traveling part 120 according to a predetermined condition. The controlling of the traveling part 120 may include moving the robot cleaner 10.

In an embodiment, the controller may control the brush motor 133 and/or the suction motor 142 according to a predetermined condition.

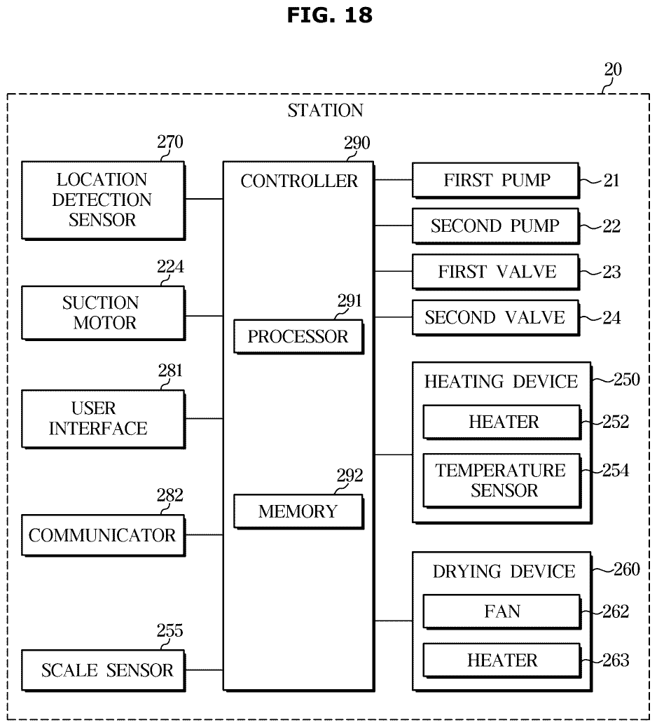

FIG. 18 is a control block diagram of a station, according to an embodiment.

Referring to FIG. 18, the station 20 may include a docking detection sensor 270, a suction motor 224, a user interface 281, a communicator 282, the first pump 21, the second pump 22, the first valve 23, the second valve 24, the heating device 250, a scale sensor 255, the drying device 260 and/or a controller 290.

The docking detection sensor 270 may detect whether the robot cleaner 10 is docked to the station 20. The docking detection sensor 270 may include at least one sensor for detecting a mechanical change and/or an electrical change when the robot cleaner 10 is docked to the station 20.

For example, the docking detection sensor 270 may include a sensor for detecting whether the charging terminal 151 of the robot cleaner 10 is electrically connected to the charging terminal 218 of the station 20. In another example, the docking detection sensor 270 may include a sensor (e.g., an elasticity sensor) for detecting mechanical deformation when the robot cleaner 10 is docked.

The controller 290 may determine whether the robot cleaner is docked to the station based on the output value of the docking detection sensor 270.

The suction motor 224 may generate suction force to draw in dirt of the dust collecting tank 141.

The controller 290 may operate the suction motor 224 to draw the dirt of the dust collecting tank 141 into the dirt collecting tank 223.

The operation of the controller 290 operating the suction motor 224 to draw the dirt of the dust collecting tank into the dirt collecting tank 223 may be called a suction process.

The user interface 281 may include an output interface and an input interface.

The at least one output interface may send various information relating to the operation of the station to the user by generating sensory information.

For example, the at least one output interface may send information relating to an operating time of the station and settings of the station to the user. The information relating to the operation of the station may be output through a display, an indicator and/or voice. The at least one output interface may include, for example, a liquid crystal display (LCD) panel, an indicator, a light emitting diode (LED) panel, a speaker, etc.

In a case that the display includes a touch screen display, the touch screen display may correspond to an example of the output interface and the input interface.

In an embodiment, the at least one output interface may output sensory information (e.g., visual information, auditory information, etc.) relating to the control of the station.

The at least one input interface may convert sensory information received from the user into an electric signal.

The at least one input interface may include a power button to power on the station.

Each button may include a visual indicator (e.g., text, an icon, etc.) that may indicate the function.

The at least one input interface may include, for example, a tact switch, a push switch, a slide switch, a toggle switch, a micro switch, a touch switch, a touch pad, a touch screen, a jog dial and/or a microphone.

In the disclosure, the button may be replaced by a user interface (UI) element, a tact switch, a push switch, a slide switch, a toggle switch, a micro switch, a touch switch, a touch pad, a touch screen, a jog dial, and/or a microphone.

The station 20 may process the user input received through the user interface 281 or output information relating to the station through the user interface 281.

In an embodiment, the user interface 281 may include an input interface for receiving a wettable cloth wash command and/or a wettable cloth steam command.

When the user determines that the wettable cloth 160 of the robot cleaner 10 needs to be washed or sterilized, the user may input the wettable cloth wash command and/or the wettable cloth steam command through the input interface.

The station 20 may perform a washing process, a steaming process and/or a drying process in response to the wettable cloth wash command and/or the wettable clothe steam command being input through the user interface 281.

The communicator 282 may communicate with an external device (e.g., a server, a user equipment or the robot cleaner 10) by the wire and/or wirelessly.

The communicator 282 may transmit or receive data to or from the external device (e.g., a server, a user equipment or the robot cleaner 10). For this, the communicator 282 may support establishment of a direct (e.g., wired) communication channel or a wireless communication channel between external devices, and communication through the established communication channel. In an embodiment, the communicator 282 may include a wireless communication module (e.g., a cellular communication module, a short-range wireless communication module or a global navigation satellite system (GNSS) communication module) or a wired communication module (e.g., a local area network (LAN) communication module or a power-line communication module). A corresponding one of the communication modules may communicate with an external device over a first network (e.g., a short-range communication network such as bluetooth, Wi-Fi direct or IrDA) or a second network (e.g., a remote communication network such as a legacy cellular network, a 5G network, a next generation communication network, the Internet, or a computer network (e.g., a LAN or WAN). These various types of communication modules may be integrated into a single component (e.g., a single chip) or implemented as a plurality of separate components (e.g., a plurality of chips).

The short-range communication module may include a bluetooth communication module, a BLE communication module, an NFC module, a WLAN, e.g., Wi-Fi, communication module, a Zigbee communication module, an IrDA communication module, a WFD communication module, an UWB communication module, an Ant+ communication module, a uWave communication module, etc., without being limited thereto.

The long-range communication module may include a communication module for performing various types of long-range communication and include a mobile communication interface. The mobile communication interface transmits and receives RF signals to and from at least one of a base station, an external terminal, or a server in a mobile communication network.

In an embodiment, the communicator 282 may communicate with the external device through a nearby access point (AP). The AP may connect a local area network (LAN) connected to the robot cleaner 10 to a wide area network (WAN) connected to the server. The station 20 may be connected to the server through the WAN.

In an embodiment, the communicator 282 may communicate with the robot cleaner 10 wirelessly.

There may be various examples of communicating between the robot cleaner 10 and the station 20.

In an embodiment, the robot cleaner 10 and the station 20 may communicate directly through the short-range communication modules.

In an embodiment, the robot cleaner 10 and the station 20 may communicate directly through wired communication while the robot cleaner 10 is docked to the station 20.

In an embodiment, the robot cleaner 10 and the station 20 may communicate indirectly via an external server through the long-range communication modules.

The indirect communication via the external server may include an occasion when the robot cleaner 10 transmits a certain signal to the external server which in turn forwards the certain signal received from the robot cleaner 10 to the station 20 and/or an occasion when the station 20 transmits a certain signal to the external server which in turn forwards the certain signal received from the station 20 to the robot cleaner 10.

The first pump 21 may be arranged to pump the water stored in the water supply tank 221 or pump the water of the heating device 250.

When the internal component of the first pump 21 is rotated in a first direction, water stored in the water supply tank 221 may be pumped, and when the internal component of the first pump 21 is rotated in a second direction that is opposite to the first direction, water of the heating device 250 may be pumped out.

The controller 290 may control the pumping direction of the first pump 21 and operate the first pump 21.

The second pump 22 may be arranged to pump the air of the wastewater tank 222.

The controller 290 may operate the second pump 22.

A water level sensor (not shown) arranged in the wastewater tank 222 may transmit information about a water level in the wastewater tank 222 to the controller 290.

The controller 290 may control the second pump 22 based on the information obtained through the water level sensor. The controller 290 may stop the second pump 22 based on the water level in the wastewater tank 222 reaching a preset water level.

The first valve 23 may be arranged to control the flow of water pumped by the first pump 21, and may operate based on the control signal of the controller 290.

The second valve 24 may be arranged to control the flow of water guided by the third pipe 203, and may operate based on the control signal of the controller 290.

The heating device 250 may include the heater 252.

The heater 252 may be arranged to heat water passing a water pipe 251 and may operate based on the control signal of the controller 290.

The heating device 250 may further include a temperature sensor 254. The temperature sensor 254 may be arranged to detect temperature of the water passing the water pipe 251, and may send information relating to temperature in the water pipe 251 to the controller 290.

In an embodiment, the controller 290 may control the heater 252 based on the temperature information received from the temperature sensor 254. For example, the controller 290 may stop the operation of the heater 252 based on the temperature detected by the temperature sensor 254 being reached.

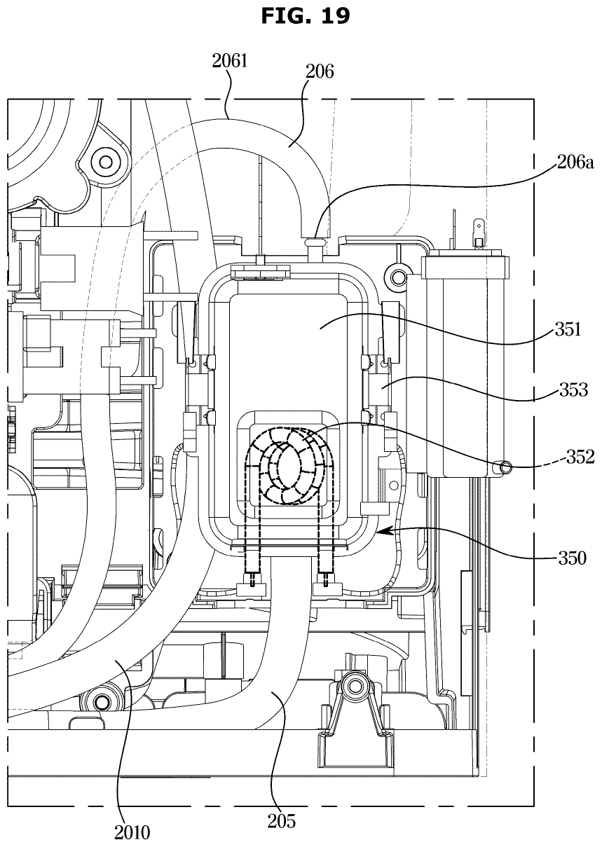

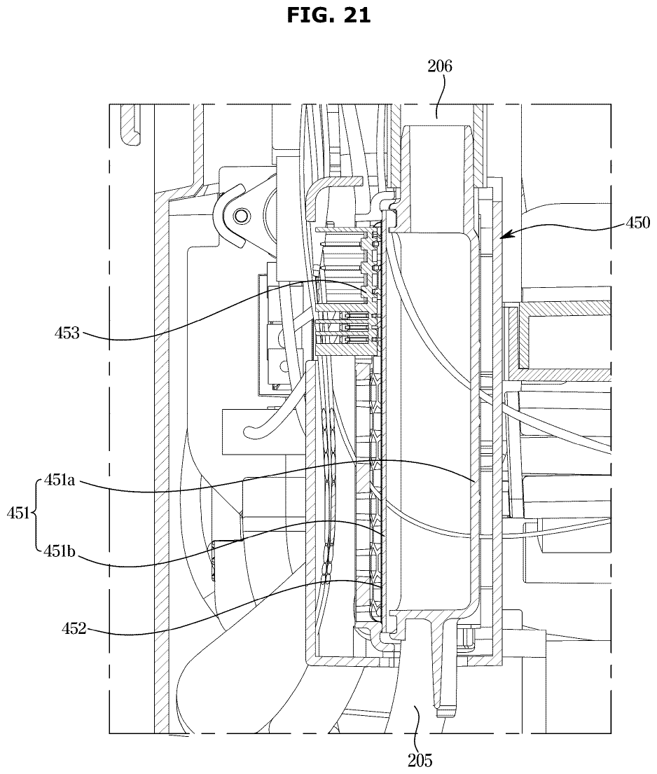

The heating device 250 may correspond to a heating device 350 or 450 (see FIG. 19 or 21) as will be described later. A heater 352 or 452 (see FIG. 19 or 21) of the heating device 350 which will be described later may correspond to the heater 252, and the heating device 350 or 450 may further include a water tub 351 or 451 (see FIG. 19 or 21) and a water level sensor 353 or 453 (see FIG. 19 or 21) which will be described later.

In the disclosure, descriptions related to the heating device 250 may also be applied to the heating device 350 or 450.

The controller 290 may perform the steaming process by controlling the at least one pump 21 and 22, the at least one valve 23 and 24 and the heating device 250 which were described above.

In an embodiment, the controller 290 may start the steaming process in response to a condition for starting the steaming process being satisfied.

In response to the steaming process being started, the controller 290 may control the first valve 23 to connect the second pipe 202 to the third pipe 203, control the second valve 24 to connect the third pipe 203 to the fifth pipe 205 and control the first pump 21 to pump the water stored in the water supply tank 221. Accordingly, the water stored in the water supply tank 221 may pass the first pipe 201, the first pump 21, the second pipe 202, the first valve 23, the third pipe 203, the second valve 24 and the fifth pipe 205 to flow to the heating device 250.

After this, based on passage of the water through the water pipe 251 being detected, the controller 290 may operate the heater 252 so that hot water and/or steam may be jetted from the heating device 250 to the washing chamber 230.

The controller 290 may operate the heater 252 while the water is passing the water pipe 251, and temporarily stop the operation of the heater 252 based on the temperature detected by the temperature sensor 254 reaching a predetermined temperature during the steaming process, thereby preventing the heater 252 from being overheated.

The controller 290 may stop the steaming process based on a condition for stopping the steaming process being satisfied.

In an embodiment, the controller 290 may stop the steaming process in response to a lapse of a predetermined time for which the steaming process is performed.

The controller 290 may turn off the heater 252 in response to completion of the steaming process.

In an embodiment, the controller 290 may start the drying process when the steaming process is stopped.

As the steaming process is performed repeatedly, scale may be deposited in the heating device 250. For example, when the steaming process is repeated, scale, e.g., CaCO3 or Mg(OH)2, may be deposited in the heating device 250 due to motions of positive ions and negative ions contained in the water supplied to the heating device 250.

The depositing of the scale in the heating device 250 may include depositing of the scale in the water pipe 251 and/or depositing of the scale in the water tub 351.

Accumulation of the scale in the heating device 250 may cause the water pipe 251 or the sixth pipe 206 to be clogged, preventing the water heated by the heater 252 from being released out of the heating device 250.

When the water heated by the heater 252 fails to be released out of the heating device 250, the internal temperature of the heating device 250 keeps rising and the internal pressure of the heating device 250 increases accordingly. As such, when the scale accumulated in the heating device 250 is not eliminated, it may cause the big risk.

The scale sensor 255 may detect the scale accumulated in the heating device 250.

The scale sensor 255 may collect information with which to estimate that a lot of scale has been made in the heating device 250. The scale sensor 255 may forward the information with which to estimate that a lot of scale has been made in the heating device 250 to the controller 290.

For example, the scale sensor 255 may include the temperature sensor 254. The controller 290 may determine that the scale has been accumulated in the heating device 250 based on the temperature detected by the temperature sensor 254 rising to more than a predetermined temperature during the steaming process.

In another example, the scale sensor 255 may include a pressure sensor for detecting internal pressure of the heating device 250. The controller 290 may determine that the scale has been accumulated in the heating device 250 based on the pressure detected by a pressure sensor rising to more than a predetermined pressure during the steaming process.

In another example, the scale sensor 255 may include a flow rate sensor for detecting a flow rate of water flowing to the water pipe 251 or the sixth pipe 206. The controller 290 may determine that the scale has been accumulated in the heating device 250 based on the flow rate detected by the flow rate sensor being equal to or lower than a predetermined flow rate during the steaming process.

In another example, the scale sensor 255 may include a water quality sensor for detecting quality of water flowing to the water pipe 251 or the sixth pipe 206 or detecting quality of water stored in the water tub 351. The controller 290 may determine that the scale is accumulated in the heating device 250 based on the water quality detected by the water quality sensor being equal to or lower than reference water quality.

The water quality sensor may include, for example, a TDS sensor, a turbidity sensor, a pH sensor, an electrical conductivity sensor, a hardness sensor, etc.

Based on a TDS value measured by the TDS sensor being larger than a predetermined value, a turbidity value detected by the turbidity sensor being larger than a predetermined value, a pH value detected by the pH sensor belonging to a predetermined pH range, an electrical conductivity detected by the electrical conductivity sensor belonging to a predetermined electrical conductivity range and/or a hardness value detected by the hardness sensor being larger than a predetermined value, the controller 290 may determine that scale is accumulated in the heating device 250.

The information obtained by the scale sensor 255 is not limited to the aforementioned example, and any sensor that is able to collect information with which to determine whether scale is accumulated in the heating device 250 may be used as an example of the scale sensor 255.

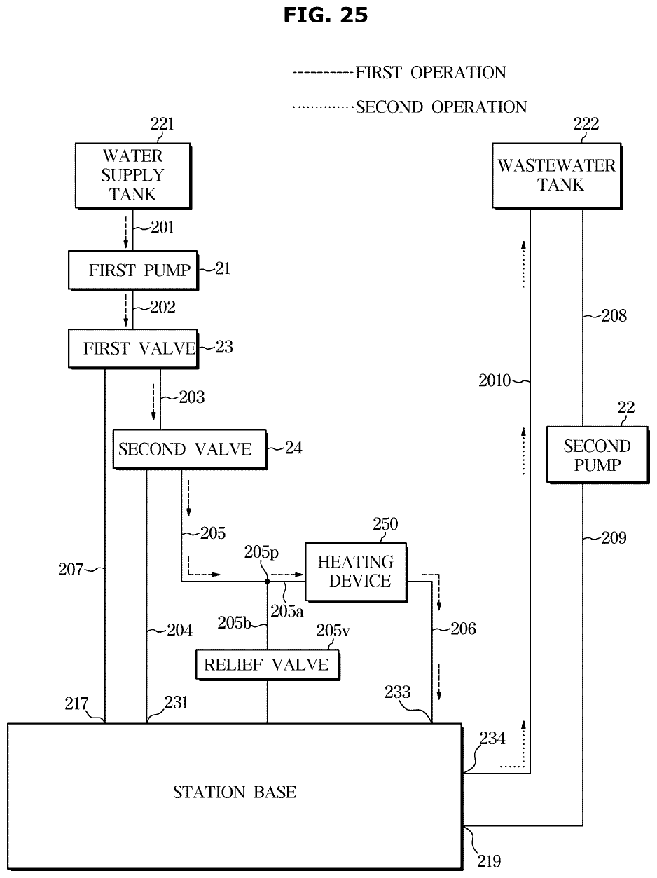

For example, as will be described later, the scale sensor 255 may further include a sensor for detecting opening of a relief valve 205v (see FIG. 25), and the controller 290 may determine that scale is accumulated in the heating device 250 based on opening of the relief valve 205v being detected.

The drying device 260 may include the heater 263 for heating air and the fan 262 for blowing the heated air. The air heated by the heater 263 may be blown to the washing chamber 230 according to the operation of the fan 262.

The controller 290 may perform the drying process by controlling the drying device 260 to blow the heated air to the washing chamber 230.

The controller 290 may perform the drying process by operating the heater 263 and the fan 262.

The controller 290 may stop the drying process according to a condition for stopping the drying process.

In an embodiment, the controller 290 may stop the drying process in response to a lapse of a predetermined time for which the drying process is performed.

In an embodiment, the controller 290 may stop the drying process in response to receiving of a request signal to stop drying from the robot cleaner 10. For this, the robot cleaner 10 may be configured to transmit the request signal to stop drying to the station 20 in response to the humidity measured by the humidity sensor 171 dropping below a predetermined humidity during the drying process.

The controller 290 may control general operation of the station 20.

The controller 290 may include at least one processor 291 for controlling operation of the station 20, and at least one memory 292 for storing a program and data for controlling the operation of the station 20.

The at least one processor 291 controls general operation of the station 20. Specifically, the at least one processor 291 may be connected to the respective components of the station 20 to control general operation of the station 20. For example, the at least one processor 291 may be electrically connected to the memory 292 to control general operation of the station 20. The processor 291 may include one or more processors.

The at least one processor 291 may execute at least one instruction stored in the memory 292 to perform operation of the station 20 according to various embodiments.

The at least one memory 292 may store data required for various embodiments. The memory 292 may be implemented in the form of a memory embedded in or detachable from the station 20 depending on the data storage use. For example, data for operating the station 20 may be stored in the memory embedded in the station 20 and data for an extended function of the station 20 may be stored in the memory detachable from the station 20. In the meantime, the memory embedded in the station 20 may be implemented with at least one of a volatile memory (e.g., a dynamic random access memory (DRAM), a static RAM (SRAM), or a synchronous dynamic RAM (SDRAM), etc.) or a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive or a solid state drive (SSD)). The memory detachable from the station 20 may be implemented in such a format as a memory card (e.g., compact flash (CF), secure digital (SD), micro-SD, mini-SD, extreme digital (xD), multi-media card (MMC), etc.) or an external memory (e.g., USB memory) connectable to a USB port.

The at least one processor 291 may include one or more of a central processing unit (CPU), a graphics processing unit (GPU), an accelerated processing unit (APU), a many integrated core (MIC), a digital signal processor (DSP), a neural processing unit (NPU), a hardware accelerator or a machine learning accelerator. The at least one processor 291 may control one or any combination of the other components of the station 20, and perform a communication related operation or data processing. The at least one processor 291 may execute at least one program or instruction stored in the memory 292. For example, the at least one processor 291 may execute the at least one instruction stored in the memory 292 to perform a method according to at least one embodiment of the disclosure.

FIG. 19 schematically illustrates internal components of a heating device, according to an embodiment of the disclosure.

Referring to FIG. 19, a heating device 350 according to an embodiment of the disclosure will be described. The same parts as those of the cleaning device 1 as shown in FIGS. 1 to 18 will have the same reference numerals, and the detailed description thereof will not be repeated.

Referring to FIG. 19, in an embodiment of the disclosure, the heating device 350 may produce hot water and/or steam. The heating device 350 may use the water stored in the water supply tank 221 to produce hot water and/or steam. The heating device 350 may receive the water stored in the water supply tank 221 to produce the hot water and/or steam.

For example, the heating device 350 may include the water tub 351 that is able to accommodate water received from the water supply tank 221.

The heating device 350 may include the heater 352 arranged to heat the water accommodated in the water tub 351. As the water in the water tub 351 is heated by the heater 352, hot water and/or steam may be produced. The controller 290 of the station 20 may control the heater 352. For example, the heater 352 may be configured to have at least a portion placed inside the water tub 351, contacting the water to heat the water.

For example, the heater 352 may use vibration and/or electrical resistance to heat the water. The disclosure is not, however, limited to the example, and any type of heater 352 may be used as long as it may heat water to produce hot water and/or steam.

The heating device 350 may include the water level sensor 353 arranged to detect a water level in the water tub 351. The controller 290 of the station 20 may operate the heater 352 based on a predetermined water level being detected by the water level sensor 353. The detecting of the predetermined water level by the water level sensor 353 may include detecting by the water level sensor 353 that the water level in the water tub 351 reaches the predetermined water level.

Hence, the heater 352 may operate only when the water tub 351 is filled with more than a certain amount of water, thereby preventing an accident such as a fire.

The heating device 350 may include the temperature sensor 254 arranged to detect temperature in the water tub 351. As will be described later, the controller 290 of the station 20 may stop the operation of the heater 352 based on the temperature detected by the temperature sensor 254 being higher than the predetermined temperature. As such, operation of the heater 352 may be stopped when the temperature of hot water and/or steam is too high, thereby preventing an accident such as a fire and damage to the cleaning device (e.g., wettable cloth).

The heating device 350 may include the heater 352, the water level sensor 353 and/or the temperature sensor 254.

The heater 352 may be arranged to heat the water accommodated in the water tub 351, and may operate based on the control signal of the controller 290.

The water level sensor 353 may be arranged to detect a water level in the water tub 351.

For example, the water level sensor 353 may be implemented with a pressure sensor, a light sensor, an ultrasonic sensor, or the like that is able to measure the water level in the water tub 351.

In another example, the water level sensor 353 may be implemented with an electrode sensor that is able to detect the water level in the water tub 351 that reaches a predetermined water level.

The water level sensor 353 may transmit information about the water level in the water tub 351 to the controller 290.

In an embodiment, the water level sensor 353 may be configured to detect that the water level in the water tub 351 reaches the predetermined water level and transmit an electric signal to the controller 290 in response to the water level in the water tub 351 reaching the predetermined water level.

The controller 290 may operate the heater 352 based on the predetermined water level being detected by the water level sensor 353.

The temperature sensor 254 may be arranged to detect temperature in the water tub 351, and may send information relating to temperature in the water tub 351 to the controller 290.

In an embodiment, the controller 290 may control the heater 352 based on the temperature information received from the temperature sensor 254. For example, the controller 290 may stop the operation of the heater 352 based on the temperature detected by the temperature sensor 254 being reached.

The controller 290 may perform the steaming process by controlling the at least one pump 21 and 22, the at least one valve 23 and 24 and the heating device 250 which were described above.

In an embodiment, the controller 290 may start the steaming process in response to a condition for starting the steaming process being satisfied.

In response to the steaming process being started, the controller 290 may control the first valve 23 to connect the second pipe 202 to the third pipe 203, control the second valve 24 to connect the third pipe 203 to the fifth pipe 205 and control the first pump 21 to pump the water stored in the water supply tank 221. Accordingly, the water stored in the water supply tank 221 may pass the first pipe 201, the first pump 21, the second pipe 202, the first valve 23, the third pipe 203, the second valve 24 and the fifth pipe 205 to flow to the heating device 350.

After this, based on the predetermined water level being detected by the water level sensor 353, the controller 290 may operate the heater 352 so that hot water and/or steam may be jetted from the heating device 350 to the washing chamber 230. The controller 290 may stop operation of the first pump 21 based on the predetermined water level being detected by the water level sensor 353.

The controller 290 may operate the heater 352 until the steaming process is completed based on the predetermined water level being detected by the water level sensor 353, and temporarily stop the operation of the heater 352 based on the temperature detected by the temperature sensor 254 reaching a predetermined temperature during the steaming process, thereby preventing the heater 352 from being overheated.

The controller 290 may stop the steaming process based on a condition for stopping the steaming process being satisfied.

In an embodiment, the controller 290 may stop the steaming process in response to the predetermined water level (a minimum water level) being detected by the water level sensor 353.

In an embodiment, the controller 290 may stop the steaming process in response to a lapse of a predetermined time for which the steaming process is performed.

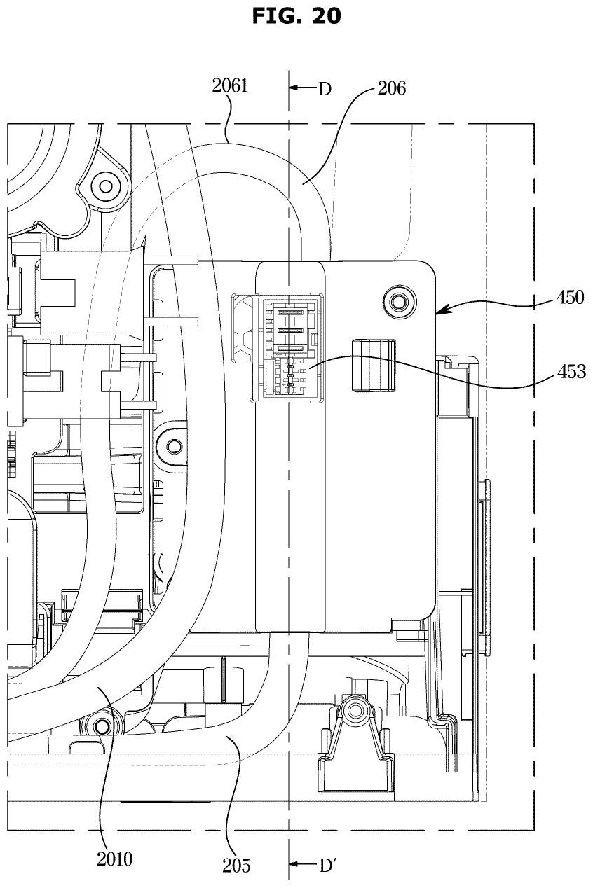

FIG. 20 is an enlarged view of a heating device, according to an embodiment of the disclosure. FIG. 21 is a cross-sectional view along line D-D′ marked in FIG. 20;.

Referring to FIGS. 20 and 21, the heating device 450 according to another embodiment of the disclosure will be described. The same parts as those of the cleaning device 1 as shown in FIGS. 1 to 18 will have the same reference numerals, and the detailed description thereof will not be repeated.

Referring to FIGS. 20 and 21, in an embodiment of the disclosure, the heating device 450 may produce hot water and/or steam. The heating device 450 may use the water stored in the water supply tank 221 to produce hot water and/or steam. The heating device 450 may receive the water stored in the water supply tank 221 to produce the hot water and/or steam.

For example, the heating device 450 may include the water tub 451 that is able to accommodate water received from the water supply tank 221. The water tub 451 may include a water tub body 451a and a water tub cover 451b.

The heating device 450 may include the heater 452 arranged to heat the water accommodated in the water tub 451. As the water in the water tub 451 is heated by the heater 452, hot water and/or steam may be produced. The controller 290 of the station 20 may control the heater 452. For example, the heater 452 may be located outside the water tub 451 and configured to heat water without contacting the water. The heater 452 may be arranged to make surface contact with at least one surface of the water tub 451.

The heating device 450 may include the water level sensor 453 for detecting a water level in the water tub 451.

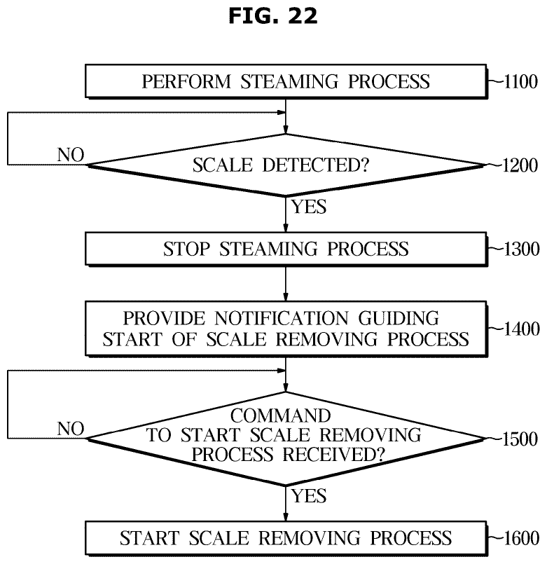

FIG. 22 is a flowchart illustrating an example of a procedure for a station to start a scale removing process, according to an embodiment of the disclosure.

Referring to FIG. 22, the controller 290 may perform the steaming process while the robot cleaner 10 is settled in the station 20.

In response to the steaming process being started, the controller 290 may control the first valve 23 to connect the second pipe 202 to the third pipe 203, control the second valve 24 to connect the third pipe 203 to the fifth pipe 205 and control the first pump 21 to pump the water stored in the water supply tank 221. Accordingly, the water stored in the water supply tank 221 may pass the first pipe 201, the first pump 21, the second pipe 202, the first valve 23, the third pipe 203, the second valve 24 and the fifth pipe 205 to flow to the heating device 250 or 350.

After this, based on passage of the water through the water pipe 251 being detected, the controller 290 may operate the heater 252 so that hot water and/or steam may be jetted from the heating device 250 or 350 to the washing chamber 230.

In other words, the controller 290 may operate the heater 252 during the steaming process.

The scale sensor 255 may detect scale accumulated in the heating device 250 or 350, in 1200.

The controller 290 may determine whether the scale is accumulated in the heating device 250 or 350 based on information collected by the scale sensor 255, in 1200.

Various examples in which the controller 290 determines whether the scale is accumulated were described above, so the overlapping description will not be repeated.

When it is determined that the scale is accumulated in the heating device 250 or 350, i.e., based on the accumulation of the scale being detected by the scale sensor 255, the controller 290 may stop the steaming process, in 1300.

The stopping of the steaming process may include stopping the operation of the first pump 21 and stopping the operation of the heater.

The controller 290 may provide a notification guiding the start of a scale removing process based on the accumulation of the scale being detected by the scale sensor 255, in 1400.

The providing of the notification guiding the start of the scale removing process may include providing a notification guiding the start of the scale removing process through the user interface 281. The providing of the notification guiding the start of the scale removing process through the user interface 281 may include outputting sensory information (e.g., visual information, auditory information, etc.) guiding the start of the scale removing process through the user interface 281.

The providing of the notification guiding the start of the scale removing process may include providing a notification guiding the start of the scale removing process through an external device. The providing of the notification guiding the start of the scale removing process through the external device may include transmitting a signal indicating that the scale removing process is required to the external device through the communicator 282.

The external device may provide a notification guiding the start of the scale removing process based on the signal indicating that the scale removing process is required being received from the station 20.

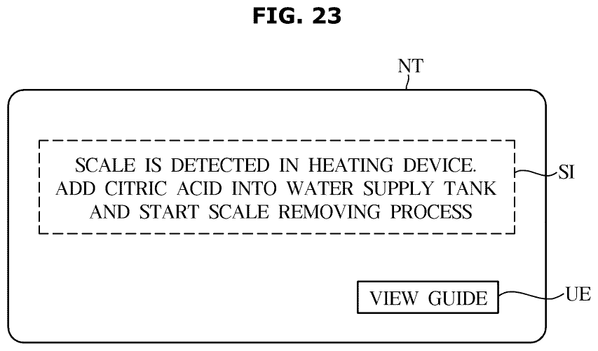

FIG. 23 illustrates an example of a notification provided by a station, according to an embodiment of the disclosure.

Referring to FIG. 23, a notification NT guiding the start of the scale removing process may include sensory information (e.g., visual indication) indicating a priory operation required for the scale removing process.

For example, the notification NT guiding the start of the scale removing process may include sensory information SI that induces to add a substance (e.g., citric acid) into the water supply tank 221 or 211 to eliminate the scale.

In another example, the notification NT guiding the start of the scale removing process may include sensory information that induces the robot cleaner 10 to keep in a state of being undocked from the station 20 before the start of a scale process.

In an embodiment, the notification NT guiding the start of the scale removing process may include a user interface element UE for providing a guide for starting the scale removing process.

When the UE is selected, the guide for starting the scale removing process may be provided.

The guide for starting the scale removing process may include sensory information (e.g., video, text, etc.) guiding a method for adding a substance into the water supply tank 221 or 211 to remove the scale and/or sensory information guiding a method for inputting a command to start the scale removing process.

In the disclosure, the user may easily perform actions required for the scale removing process before the start of the scale removing process.

A command to start the scale removing process (hereinafter, a scale removing command) may be received by the user interface 281, or received from an external device through the communicator 282.

In other words, the user may use the user interface 281 to input the scale removing command in person or use the external device to input the scale removing command remotely.

Based on the scale removing command being received in 1500, the controller 290 may start the scale removing process in 1600.

In various embodiments, when the station 20 includes a configuration (e.g., a storage tank for storing the citric acid, and an actuator for automatically moving the storage tank to supply the citric acid stored in the storage tank to the water supply tank 221) for supplying a substance to the water supply tank 221 to automatically eliminate the scale, operations 1400 and 1500 may be omitted.

In other words, when the station 20 includes a configuration for supplying the substance to automatically eliminate the scale, the controller 290 may omit operations 1400 and 1500 and start the scale removing process right away.

In an embodiment, based on the scale removing command being received while the robot cleaner 10 is settled in the station 20, the controlled 290 may control the communicator 282 to transmit an undocking command to the robot cleaner 10.

After this, the controller 290 may control the communicator 282 to transmit a docking command to the robot cleaner 10 based on the scale removing process being completed.

The robot cleaner 10 may undock from the station 20 based on receiving of the undocking command from the station 20, and keep in the state of being undocked from the station 20 until receiving the docking command.

In the disclosure, the wettable cloth 160 of the robot cleaner 10 may be prevented from being contaminated with the wastewater having the scale deposited therein discharged into the washing chamber 230 during the scale removing process.

The controller 290 may control the first pump 21 to eliminate the scale accumulated in the heating device 250 or 350 in the scale removing process.

In order to remove the scale, an aqueous solution in which the substance for eliminating the scale is dissolved needs to stay in the heating device 250 or 350 for a long time.

For convenience of explanation, the aqueous solution with the substance for eliminating the scale dissolved therein will now be referred to as a citric acid solution, but it is obvious that the type of aqueous solution may vary depending on the type of substance for eliminating the scale.

In an embodiment, the controller 290 may control the rpm of the first pump 21 in the scale removing process to be lower than the rpm of the first pump 21 in the steaming process.

In other words, the controller 290 may operate the first pump 21 at first rpm in the scale removing process and operate the first pump 21 at second rpm higher than the first rpm in the steaming process.

As will be described below, the controlling of the first pump 21 may include controlling the direction of water supplied by the first pump 21 (or controlling the first valve and/or second valve).

In a case that much scale is deposited in the heating device 250 or 350, a safety accident is likely to be caused by operation of the heater 252.

The controller 290 may not operate the heater 252 in the scale removing process.

In the meantime, there may be different methods of scale removing process depending on various structures of the heating device 250 or 350.

For example, when the heating device 250 or 350 includes the water pipe 251 without the water tub 351 or 451, the controller 290 may perform the scale removing process based on a first algorithm. When the heating device 250 or 350 includes the water tub 351 or 451, the controller 290 may perform the scale removing process based on a second algorithm that is different from the first algorithm.

The first and second algorithms may be stored in the memory 292 in advance.

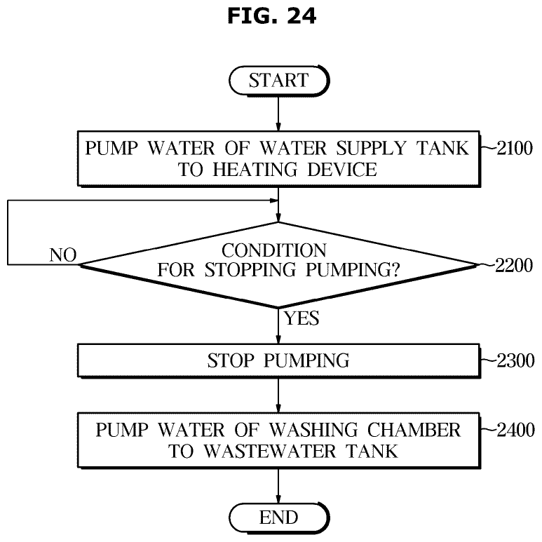

FIG. 24 is a flowchart illustrating an example of a procedure for a scale removing process when a heating device includes a water pipe and a heater, according to an embodiment of the disclosure. FIG. 25 schematically illustrates flows of water when a station performs a scale removing process, according to an embodiment of the disclosure.

In an embodiment, the heating device 250 may include the water pipe 251 and the heater 252. When the heating device 250 includes the water pipe 251, the water tub 351 or 451 may not be included.

Referring to FIGS. 24 and 25, the station 20 may include the relief valve 205v.

In an embodiment, the fifth pipe 205 may be divided by a three-way port 205p into a first flow path 205a directed to the heating device 250 and a second flow path 205b directed to the washing chamber 230.

The first flow path 205a may guide the water pumped from the water supply tank 221 to the heating device 250, and the second flow path 205b may guide the water pumped from the water supply tank 221 and/or the water in the heating device 250 (e.g., water in the water pipe 251) to the washing chamber 230.

In other words, the second flow path 205b may be branched from the first flow path 205a to guide the water flowing to the first flow path 205a to the washing chamber 230.

The relief valve 205v may open or close the second flow path 205b.

The relief valve 205v may be opened when internal pressure of the heating device 250 rises. For example, the relief valve 205v may be opened when the internal pressure of the heating device 250 is equal to or higher than predetermined pressure.

When the water heated by the heater 252 is not discharged out of the heating device 250, internal temperature of the heating device 250 continues to rise, so the internal pressure of the heating device 250 increases, and thus the relief valve 205v is opened so that hot and high pressure water may be discharged into the washing chamber 230.

According to the disclosure, safety accidents caused by the rise of internal pressure of the heating device 250 may be prevented by the relief valve 205v.

As an example of the scale sensor 255, a sensor for detecting the opening of the relief valve 205v or detecting the flow of water through the second flow path 205b may be used.

The controller 290 may stop the steaming process when the opening of the relief valve 205v is detected or the flow of water through the second flow path 205b is detected.

The controller 290 may start the scale removing process based on the scale removing command after the opening of the relief valve 205v is detected or the flow of water through the second flow path 205b is detected.

The controller 290 may perform a first operation 2100 of pumping the water in the water supply tank 221 to the heating device 250.

In an embodiment, the controller 290 may control the first pump 21 to pump the water in the water supply tank 221 to the heating device 250.

The controlling of the first pump 21 to pump the water in the water supply tank 221 to the heating device 250 may include controlling the at least one valve 23 and 24 to guide the water in the water supply tank 221 to the heating device 250. The controller 290 may control the first valve 23 to connect the second pipe 202 to the third pipe 203, control the second valve 24 to connect the third pipe 203 to the fifth pipe 205 and control the first pump 21 to pump the water stored in the water supply tank 221.

The water (or the citric acid solution) pumped to the heating device 250 by the first operation 2100 may eliminate scale in the water pipe 251 and may then be discharged to the sixth pipe 206.

The water (or the citric acid solution) discharged through the sixth pipe 206 may be guided into the washing chamber 230.

As described above, it requires sufficient time for the citric acid solution to eliminate the scale while passing the water pipe 251, so the target rpm of the first pump 21 in the scale removing process may be lower than the target rpm of the first pump 21 in the steaming process.

Based on a condition for completion of pumping being satisfied in 2200, the controller 290 may stop pumping in 2300.

The condition for completion of pumping may include complete exhaustion of the water in the water supply tank 221, operation of the first pump 21 for a predetermined period of time, etc.

For example, the station 20 may include a flow sensor for measuring the flow of water flowing to the heating device 250. The flow sensor may measure the flow of water flowing to the water pipe 251.

The controller 290 may stop pumping based on no water flow being detected by the flow sensor.

The controller 290 may stop pumping based on the first pump 21 being operated for a predetermined period of time.

The stopping of the pumping may include stopping the operation of the first pump 21.

According to the disclosure, by supplying the citric acid solution to the heating deice 250 in the scale removing process, the scale accumulated in the heating device 250 may be eliminated.

As the citric acid solution is discharged into the washing chamber 230 after removing the scale, there is a concern about contamination of the wettable cloth 160 when the robot cleaner 10 is docked to the station 20 later and settles the wettable cloth 160 onto the washing frame 240.

After stopping the pumping, the controller 290 may perform a second operation 2400 of pumping the water in the washing chamber 230 to the wastewater tank 222.

The pumping of the water in the washing chamber to the wastewater tank 222 may include operating the second pump.

The wastewater accommodated in the washing chamber 230 may be guided to the wastewater tank 222 by the second operation 2400.

The controller 290 may stop the scale removing process when the second operation is completed, and notify the completion of the scale removing process to the user.

For example, the controller 290 may provide a notification indicating the completion of the scale removing process for the user.

The providing of the notification indicating the completion of the scale removing process may include providing a notification indicating the completion of the scale removing process through the user interface 281.

The providing of the notification indicating the completion of the scale removing process may include transmitting a signal indicating that the scale removing process is completed to an external device through the communicator 282

The controller 290 may transmit, to the robot cleaner 10, the signal indicating the completion of the scale removing process to the user. The signal indicating the completion of the scale removing process may correspond to the docking command.

The robot cleaner 10 may be docked to the station 20 based on receiving the docking command from the station 20.

The aforementioned operations performed by the station 20 after completion of the scale removing process may be equally performed in the future event when the scale removing process is completed.

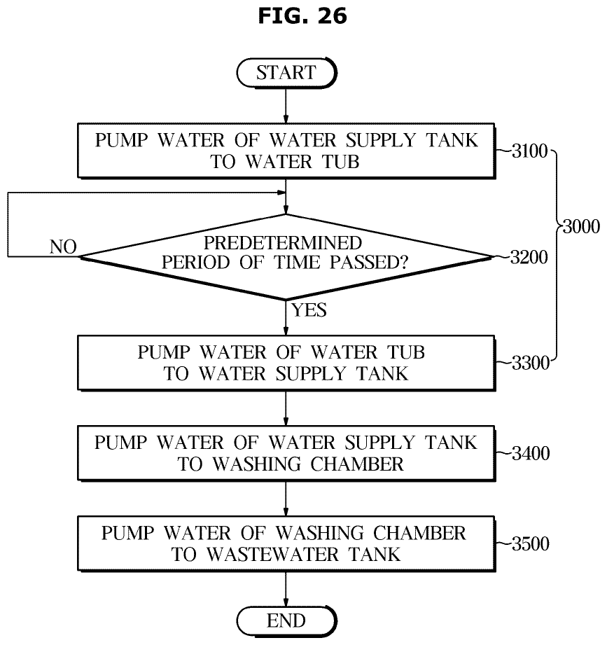

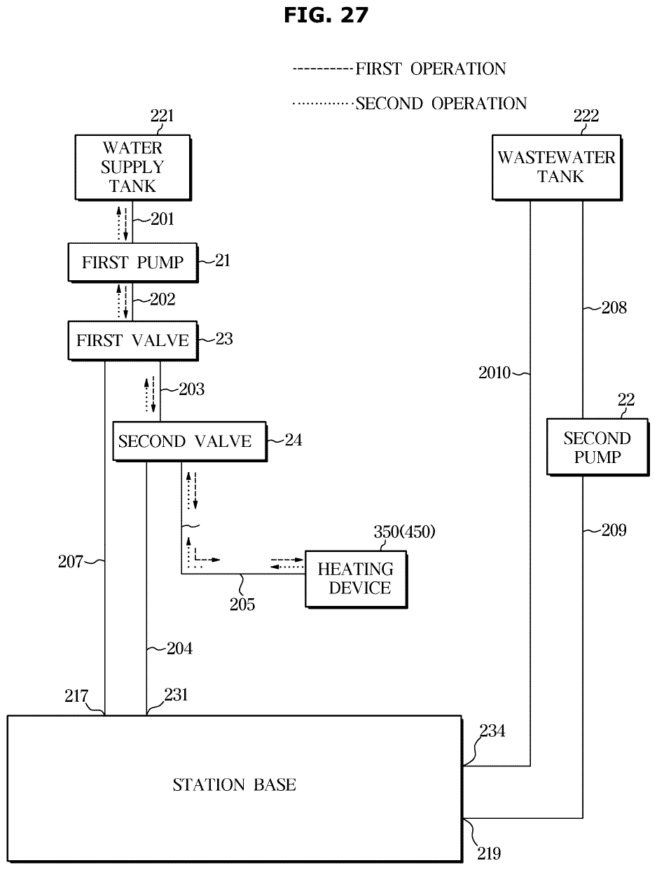

FIG. 26 is a flowchart illustrating an example of a procedure for a scale removing process when a heating device includes a water tank and a heater, according to an embodiment of the disclosure. FIG. 27 schematically illustrates flows of water when a station performs a scale removing process, according to an embodiment of the disclosure.

In an embodiment, the heating device 350 or 450 may include the water tub 351 or 451 and the heater.

In an embodiment, the controller 290 may control the first pump 21 to move the water in the water tub 351 or 451 into the water supply tank 221 based on detecting of the scale (in the example of 1200 of FIG. 22).

For example, the controller 290 may control the first valve 23 to connect the second pipe 202 to the third pipe 203, control the second valve 24 to connect the third pipe 203 to the fifth pipe 205 and control the first pump 21 to pump the water stored in the water tub 351 or 451 to the water supply tank 221.

In an embodiment, the controller 290 may control the first pump 21 to discharge the water in the water supply tank 221 to the washing chamber 230 after controlling the first pump 21 to move the water in the water tub 351 or 451 to the water supply tank 221.

For example, the controller 290 may control the first valve 23 to connect the second pipe 202 to the seventh pipe 207 and control the first pump 21 to pump the water of the water supply tank 221.

In the disclosure, before the start of the scale removing process, especially before the user adds the citric acid solution into the water supply tank 21, the water stored in the water tub 351 or 451 may be moved into the water supply tank 221 or discharged into the washing chamber 230 in advance.

According to the disclosure, by performing the scale removing process while the water tub 351 or 451 is empty, the citric acid solution, when sent to the water tub 351 or 451, may efficiently eliminate the scale.

As a certain amount of time is required until the user inputs the scale removing command after the scale is detected, the controller 290 may perform an operation of controlling the first pump 21 to move the water in the water tub 351 or 451 to the water supply tank 221 before receiving the scale removing command after the scale is detected.

After moving the water in the water tub 351 or 451 to the water supply tank 221, the controller 290 may start the scale removing process by receiving the scale removing command.

Referring to FIGS. 26 and 27, the controller 290 may perform a first operation 3100 of pumping the water of the water supply tank 221 to the water tub 351 or 451.

The pumping of the water of the water supply tank 221 to the water tub 351 or 451 may include controlling the at least one valve 23 and 24 to guide the water of the water supply tank 221 to the water tub 351 or 451. The controller 290 may control the first valve 23 to connect the second pipe 202 to the third pipe 203, control the second valve 24 to connect the third pipe 203 to the fifth pipe 205 and control the first pump 21 to pump the water stored in the water supply tank 221.

The pumping of the water of the water supply tank 221 to the water tub 351 or 451 may include pumping the water of the water supply tank 221 to the water tub 351 or 451 until the water level in the water tub 351 or 451 reaches a predetermined water level.

The controller 290 may stop operation of the first pump 21 based on the predetermined water level being detected by the water level sensor 353 or 453 arranged to detect the water level in the water tub 351 or 451. The predetermined water level may include a full water level.

The pumping of the water of the water supply tank 221 to the water tub 351 or 451 may include operating the first pump 21 for a predetermined period of time. The predetermined period of time may be set in advance as a time required for the water level in the water tub 351 or 451 to reach the predetermined water level.

The controller 290 may perform a second operation 3300 of pumping the water of the water tub 351 or 451 to the water supply tank 221, based on a lapse of a predetermined period of time after the water of the water supply tank 221 is pumped to the water tub 351 or 451. The predetermined period of time may be a time that is sufficient for the citric acid solution to remove the scale and may be set in advance.

During the predetermined period of time after the first operation 3100 is performed, the citric acid solution may remove the scale in the heating device 350 or 450.

By the second operation 3300, a solution with the scale dissolved therein may be collected into the water supply tank 221.

The controller 290 may repeat the aforementioned operations 3000 (3100, 3200 and 3300) as many as a predetermined number of times. The predetermined number of times may be set in advance as a proper number of times for removing the scale.

According to the disclosure, by repeatedly performing the aforementioned operations 3000 (3100, 3200 and 3300), scale in the heating device 350 or 450 may be efficiently removed.

After repeating the aforementioned operations 3000 (3100, 3200 and 3300) as many as the predetermined number of times, the controller 290 may control the first pump 21 to pump the water of the water supply tank 221 to the washing chamber 230 in 3400. For example, the controller 290 may control the first valve 23 to connect the second pipe 202 to the seventh pipe 207 and control the first pump 21 to pump the water in the water supply tank 221.

The controller 290 may pump the water of the washing chamber 230 to the wastewater tank 222 in 3500 after pumping the water of the water supply tank 221 to the washing chamber 230.

In various embodiments, operation 3500 may be omitted.

When operation 3500 is omitted, the controller 290 may complete the scale removing process by pumping the water of the water supply tank 221 to the washing chamber 230. In this case, the controller 290 may provide a notification for the user to throw away the water from the water supply tank 221.

The operation of pumping the water of the washing chamber 230 to the wastewater tank 222 corresponds to operation 2400 of FIG. 24, so the overlapping description will not be repeated.

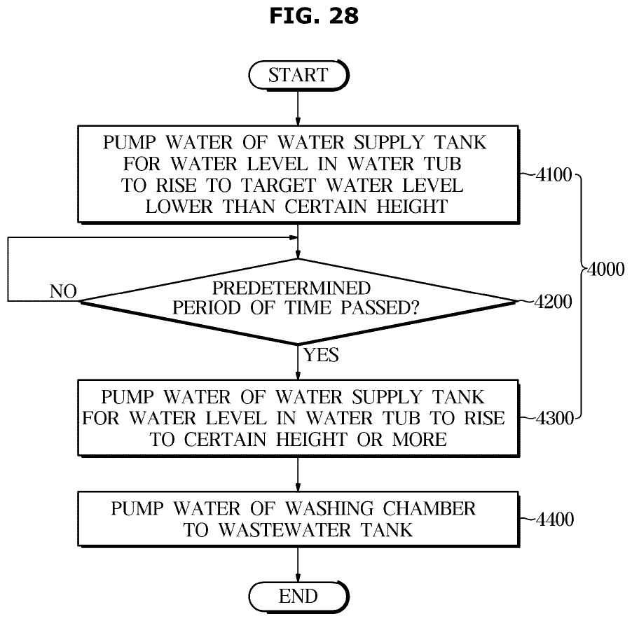

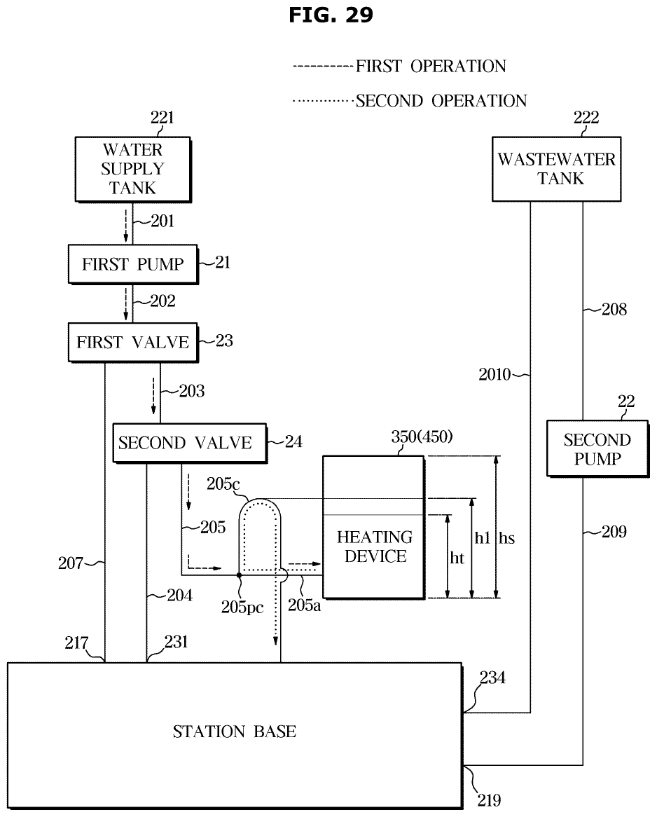

FIG. 28 is a flowchart illustrating another example of a procedure for a scale removing process when a heating device includes a water tank and a heater, according to an embodiment of the disclosure. FIG. 29 schematically illustrates flows of water when a station performs a scale removing process, according to an embodiment of the disclosure.

In an embodiment, the heating device 350 or 450 may include the water tub 351 or 451 and the heater 352 or 452.

Referring to FIGS. 28 and 29, the station 20 may include a detour pipe 205c branched from the fifth pipe 205. The detour pipe 205c may also be referred to as a siphon pipe in that it allows the water in the water tub 351 or 451 to be discharged into the washing chamber 230 according to the siphon principle.

The fifth pipe 205 may form a first flow path that guides the water pumped from the water supply tank 221 to the heating device 350 or 450.

The fifth pipe 205 may be branched with the detour pipe 205c by a three-way port 205pc.

An end of the detour pipe 205c may be connected to the three-way port 205pc and the other end of the detour pipe 205c may be directed to the washing chamber 230. The other end of the detour pipe 205c may be arranged in a location lower than the bottom of the water tub 351 or 451.

The detour pipe 205c may extend upward to a certain height h1 lower than height hs of the water tub 351 or 451, bend and extend downward toward the washing chamber 230. The extending downward toward the washing chamber 230 may refer to extending to a location lower than the bottom of the water tub 351 or 451.

With the detour pipe 205c, a second flow path may be formed, which is branched from the first flow path, extends upward to the certain height h1 lower than the height hs of the water tub 351 or 451, bends and extends downward toward the washing chamber 230. The certain height h1 may be set in advance as a proper height lower than the height hs of the water tub 351 or 451 and higher than half the height hs of the water tub 351 or 451.

When the water level of the water tub 351 or 451 rises to the certain height h1 or more, the water in the water tub 351 or 451 may be discharged into the washing chamber 230 through the second flow path formed by the detour pipe 205c according to the siphon principle.

When the water level in the water tub 351 or 451 remains at less than the certain height h1 after the water of the water tub 351 or 451 is discharged, the water of the water tub 351 or 451 is not discharged into the washing chamber 230.

According to the disclosure, by installing the detour pipe 205c, the water in the water tub 351 or 451 may be discharged into the washing chamber 230 even without a pumping operation.

As described above, the controller 290 may release the water in the water tub 351 or 451 into the washing chamber 230 before the start of the scale removing process.

In an embodiment, the controller 290 may release the water in the water tub 351 or 451 into the washing chamber 230 by controlling the first pump 21 so that the water level in the water tub 351 or 451 rises to the certain height h1 or more before the start of the scale removing process.

In this case, information regarding the water level in the water tub 351 or 451 may be collected by the water level sensor 353 or 453.

The controller 290 may perform a first operation 4100 of pumping the water in the water supply tank 221 in order for the water level in the water tub 351 or 451 to rise to a target water level ht that is lower than the certain height h1 in the scale removing process.

For example, the controller 290 may operate the first pump 21 to pump the water in the water supply tank 221 to the water tub 351 or 451 based on the start of the scale removing process, and stop operating the first pump 21 based on the water level in the water tub 351 or 451 reaching the target water level ht.

The target water level ht may be lower than the certain water level h1, and may be set in advance.

By the first operation 4100, a citric acid solution may be moved to the water tub 351 or 451, reaching the target water level ht, to eliminate the scale in the heating device 350 or 450.

During the predetermined period of time after the first operation 4100 is performed, the citric acid solution may remove the scale in the heating device 350 or 450.

Based on a lapse of a predetermined period of time in 4200 after the water in the water supply tank 221 is pumped to the water tub 351 or 451, the controller 290 may perform a second operation 4300 of pumping the water in the water supply tank 221 to the water tub 351 or 451 so that the water level in the water tub 351 or 451 rises to the certain height h1 or more. The predetermined period of time may be a time that is sufficient for the citric acid solution to remove the scale and may be set in advance.

When the water level in the water tub 351 or 451 rises to the certain height h1 or more, the water in the water tub 351 or 451 may be discharged into the washing chamber 230 through the second flow path formed by the detour pipe 205c.

By the second operation 4300, a solution with the scale dissolved therein may be discharged into the washing chamber 230.

The controller 290 may repeat the aforementioned operations 4000 (4100, 4200 and 4300) as many as a predetermined number of times. The predetermined number of times may be set in advance as a proper number of times for removing the scale.

According to the disclosure, by repeatedly performing the aforementioned operations 3000 (3100, 3200 and 3300), scale in the heating device 350 or 450 may be efficiently removed.

The controller 290 may pump the water in the washing chamber 230 to the wastewater tank 222 in 4400 after performing the aforementioned operations 3000 (3100, 3200 and 3300).

According to the disclosure, as the water from which the scale is eliminated is discharged directly into the washing chamber 230 without going through the water supply tank 221, the water supply tank 221 may be prevented from being contaminated.

According to an embodiment, a cleaning device includes a main body, a robot cleaner including a wettable cloth detachably mounted on a bottom portion of the main body, and a station arranged to cradle the robot cleaner. The station includes a water supply tank arranged to store water, a washing chamber corresponding with the wettable cloth while the robot cleaner is cradled in the station, a heating device configured to heat water supplied from the water supply tank, a pump arranged to pump water stored in the water supply tank, and a controller configured to control the pump to remove scale accumulated in the heating device in a scale removing process.

The station may further include a scale sensor for detecting scale accumulated in the heating device

The station may further include a first flow path guiding water pumped from the water supply tank to the heating device, the second flow path branched from the first flow path to guide water flowing to the first flow path to the washing chamber, and a relief valve opening or closing the second flow path. The relief valve may be configured to be opened with an increase of internal pressure of the heating device. The scale sensor may be configured to detect opening of the relief valve or a flow of water through the second flow path.

The heating device may include a water pipe allowing water supplied from the water supply tank to pass through, and a heater arranged to be adjacent to the water pipe to heat water passing the water pipe

The water pipe may include a bending portion. The heater may include a bending portion to correspond with the bending portion of the water pipe.

The heating device may include a water tub for storing water supplied from the water supply tank, and a heater for heating water stored in the water tub.

The heater may be configured to have at least a portion inside the water tub contact water stored in the water tub to heat the water stored in the water tub.

The heater may be configured to heat, outside the water tub, the water stored in the water tub without contacting the water stored in the water tub.

The controller may provide a notification guiding a start of the scale removing process for the user based on accumulation of the scale being detected by the scale detection sensor. The notification may include sensory information inducing to add a substance for removing the scale into the water supply tank.

The controller may operate the pump to supply the water stored in the water supply tank to the heating device based on the start of the scale removing process. The water supplied to the heating device according to operation of the pump may be discharged to the washing chamber through the water pipe.

The controller may be configured to control the pump to jet steam produced by the heating device to the washing chamber in a steaming process, operate the pump at a first rpm in the scale removing process, and operate the pump at a second rpm higher than the first rpm in the steaming process.

The controller may perform a first operation of controlling the pump to pump the water stored in the water supply tank to the water tub based on the scale removing process being started, and perform a second operation of controlling the pump to pump the water stored in the water tub to the water supply tank based on a lapse of a predetermined time after performing the first operation.

The controller may control the pump to pump the water stored in the water supply tank to the washing chamber after repeating the first operation and the second operation as many as a predetermined number of times.

The station may further include a first flow path which guides the water pumped from the water supply tank to the heating device, and a second flow path branched from the first flow path, extending upward to a predetermined height lower than the height of the water tub, bending, and extending downward toward the washing chamber. The controller may perform a first operation of controlling the pump so that the water level in the water tub rises to a target water level lower than the predetermined height based on the scale removing process being started, and perform a second operation of controlling the pump so that the water level in the water tub rises to the predetermined height or more based on a lapse of a predetermined time after performing the first operation.

In an embodiment, the station includes a water supply tank arranged to store water, a washing chamber arranged to wash wettable cloth of a robot cleaner, a heating device configured to heat water supplied from the water supply tank, a pump arranged to pump water stored in the water supply tank, and a controller configured to control the pump to remove scale accumulated in the heating device in a scale removing process.

The station may further include a scale sensor for detecting scale accumulated in the heating device. The controller may provide a notification guiding a start of the scale removing process for the user based on accumulation of the scale being detected by the scale detection sensor. The notification may include sensory information inducing to add a substance for removing the scale into the water supply tank.

The heating device may include a water pipe allowing water supplied from the water supply tank to pass through, and a heater arranged to be adjacent to the water pipe to heat water passing the water pipe The controller may operate the pump to supply the water stored in the water supply tank to the heating device based on the start of the scale removing process. The water supplied to the heating device according to operation of the pump may be discharged to the washing chamber through the water pipe.

The heating device may include a water tub for storing water supplied from the water supply tank, and a heater for heating water stored in the water tub. The controller may perform a first operation of controlling the pump to pump the water stored in the water supply tank to the water tub based on the scale removing process being started, and perform a second operation of controlling the pump to pump the water stored in the water tub to the water supply tank based on a lapse of a predetermined time after performing the first operation.

The controller may control the pump to pump the water stored in the water supply tank to the washing chamber after repeating the first operation and the second operation as many as a predetermined number of times.

The heating device may include a water tub for storing water supplied from the water supply tank, and a heater for heating water stored in the water tub. The station may further include a first flow path guiding water pumped from the water supply tank to the heating device, and a second flow path branched from the first flow path, extending upward to a predetermined height lower than the height of the water tub, bending, and extending downward toward the washing chamber. The controller may perform a first operation of controlling the pump so that the water level in the water tub rises to a target water level lower than the predetermined height based on the scale removing process being started, and perform a second operation of controlling the pump so that the water level in the water tub rises to the predetermined height or more based on a lapse of a predetermined time after performing the first operation.

According to the disclosure, a station and a cleaning device may have better convenience of use because a wettable cloth may be washed by a heating device.

According to the disclosure, a station and a cleaning device may reduce performance degradation by removing scale generated by a heating device.

The effects according to the disclosure are not limited thereto, and throughout the specification it will be clearly appreciated by those of ordinary skill in the art that there may be other effects unmentioned.

Several embodiments of the disclosure have been described above, but a person of ordinary skill in the art will understand and appreciate that various modifications can be made without departing from the scope of the disclosure. Thus, it will be apparent to those of ordinary skill in the art that the true scope of technical protection is only defined by the following claims.

1. A cleaning device comprising:
a robot cleaner including a main body and a wettable cloth detachably mountable on a bottom portion of the main body; and
a station to which the robot cleaner is dockable, the station including: a tank configured to store water and, during a scale removing process, to store a solution including a substance for eliminating scale,
a heating device,
a pump, and
a controller configured to:
with the robot cleaner docked to the station, control the pump to pump water stored in the tank to the heating device to be heated by the heating device, and
during the scale removing process, with the robot cleaner not docked to the station, control the pump to pump solution stored in the tank to the heating device so that scale, accumulated in the heating device by water being heated by the heating device, is removed by the substance included in the solution by the scale removing process.

2. The cleaning device of claim 1, wherein the station further includes a scale sensor configured to detect the scale accumulated in the heating device.

3. The cleaning device of claim 2, wherein
the station further includes:
a washing chamber configured to, with the wettable cloth mounted on the bottom portion of the main body and with the robot cleaner docked to the station, align with the wettable cloth,
a first flow path configured to guide water or solution pumped from the tank to the heating device,
a second flow path branched from the first flow path and configured to guide water or solution from the first flow path to the washing chamber; and
a relief valve configured to open and close the second flow path,
wherein the relief valve is configured to open with an increase of internal pressure of the heating device, and
the scale sensor is configured to detect opening of the relief valve, or a flow of water or solution through the second flow path.

4. The cleaning device of claim 1, wherein
the heating device includes:
a pipe configured to allow water or solution pumped from the tank to pass therethrough; and
a heater adjacent to the pipe and configured to heat water or solution passing through the pipe.

5. The cleaning device of claim 4, wherein
the pipe includes a first bending portion, and
the heater includes a second bending portion corresponding with the first bending portion.

6. The cleaning device of claim 1, wherein
the heating device includes:
a tub configured to store water or solution pumped from the tank; and
a heater configured to heat water or solution stored in the tub.

7. The cleaning device of claim 6, wherein at least a portion of the heater is inside the tub and configured to contact and heat water or solution stored in the tub.

8. The cleaning device of claim 6, wherein the heater is outside the tub and configured to heat, without contacting, water or solution stored in the tub.

9. The cleaning device of claim 2, wherein
the controller is further configured to provide a notification to a user to guide a start of the scale removing process based on the scale accumulated in the heating device being detected by the scale sensor, and
the notification includes sensory information to indicate that the substance for eliminating scale is to be added into the tank.

10. The cleaning device of claim 4, wherein
the station further includes a washing chamber configured to, with the wettable cloth mounted on the bottom portion of the main body and with the robot cleaner docked to the station, align with the wettable cloth, and
the controller is further configured to:
based on the scale removing process being started, operate the pump to pump water or solution stored in the tank to the heating device, and
the water or solution pumped to the heating device by operation of the pump is discharged to the washing chamber through the pipe.

11. The cleaning device of claim 1, wherein
the station further includes a washing chamber configured to, with the wettable cloth mounted on the bottom portion of the main body and with the robot cleaner docked to the station, align with the wettable cloth, and
the controller is further configured to:
control the pump such that steam produced by the heating device jets to the washing chamber in a steaming process,
operate the pump at a first rpm in the scale removing process, and
operate the pump at a second rpm greater than the first rpm in the steaming process.

12. The cleaning device of claim 6, wherein
the controller is further configured to:
based on the scale removing process being started,
control the pump to pump solution stored in the tank to the tub in performance of a first operation, and
based on a lapse of a predetermined time after the first operation is performed, control the pump to pump the solution stored in the tub to the tank, in performance of a second operation.

13. The cleaning device of claim 12, wherein
the station further includes a washing chamber configured to, with the wettable cloth mounted on the bottom portion of the main body and with the robot cleaner docked to the station, align with the wettable cloth, and
based on the scale removing process being started,
the controller is further configured to:
control the pump to pump solution stored in the tank to the washing chamber after the first operation and the second operation are repeated a predetermined number of times.

14. The cleaning device of claim 6, wherein
the station further includes:
a washing chamber,
a first flow path configured to guide water or solution pumped from the tank to the heating device; and
a second flow path branched from the first flow path, extending upward to a predetermined height lower than a height of the tub, and then bending and extending downward toward the washing chamber, and
the controller is configured to:
based on the scale removing process being started,
control the pump so that a water level in the tub rises to a target water level lower than the predetermined height in performance of a first operation, and
based on a lapse of a predetermined time after the first operation is performed, control the pump so that the water level rises to the predetermined height or more.

15. A station to which a robot cleaner is dockable, the station comprising:
a tank configured to store water and, during a scale removing process, to store a solution including a substance for eliminating scale;
a heating device;
a pump; and
a controller configured to:
with the robot cleaner docked to the station, control the pump to pump water stored in the tank to the heating device to be heated by the heating device, and
during the scale removing process, with the robot cleaner not docked to the station, control the pump to pump solution stored in the tank to the heating device so that scale, accumulated in the heating device by water being heated by the heating device, is removed by the substance included in the solution by the scale removing process.
